(19) United States
(12) Patent Application Publication
(10) Pub. No.: US 2012/0000934 A1
(43) Pub. Date: Jan. 5, 2012

(54) DISPENSING APPLIANCE FOR DISPENSING A BEVERAGE FROM A POWDERED BEVERAGE CONTAINER

(75) Inventors: David Carl Ulstad, Dublin, OH (US); Wilson George Zeitler, Westerville, OH (US); Tobe Cohen, New Albany, OH (US); Guarav Rohatgi, Waltham, MA (US); Ilan E. Moyer, Potomac, MD (US); Andrew Boyce, Hopkinton, MA (US); Zachary Traina, Hingham, MA (US); Philip Charles Walker, Concord, MA (US); Allan Lee Cameron, Natick, MA (US)

(73) Assignee: ABBOTT LABORATORIES, Abbott Park, IL (US)

(21) Appl. No.: 12/981,147

(22) Filed: Dec. 29, 2010

Related U.S. Application Data
(60) Provisional application No. 61/291,625, filed on Dec. 31, 2009.
(60) Provisional application No. 61/291,629, filed on Dec. 31, 2009.

(51) Int. Cl. B67D 7/74; B65B 1/04

(52) U.S. Cl. 222/129.4; 141/2; 222/325

(57) ABSTRACT

In a dispensing appliance for dispensing a beverage from a powdered beverage container, a cartridge includes a container containing powdered beverage, and a dispenser on the container operable to dispense powdered beverage from the container. The appliance includes a mount for removably supporting the cartridge on the dispensing appliance, and a drive system configured for operative connection with the dispenser upon loading of the cartridge into the mount. The drive system is operable to operate the dispenser to release powdered beverage from the container. The beverage may be dispensed from the appliance in its powder form, or mixed with a liquid and dispensed generally in a liquid form. In a method of refilling a dispensing appliance, an empty cartridge of powdered beverage is replaced with a new, substantially full cartridge of powdered beverage with the cartridge dispenser operatively connected to the drive system of the appliance.

### CROSS-REFERENCE

This application is a U.S. non-provisional application of U.S. provisional application Ser. No. 61/291,625 filed Dec. 31, 2009 and entitled Packaging for Powdered Beverage and Dispenser Therefor, and is also a U.S. non-provisional application of U.S. provisional application Ser. No. 61/291,629, filed Dec. 31, 2009 and entitled Dispensing Appliance for Dispensing a Beverage from a Powdered Beverage Container, the entirety of each of which is incorporated herein by reference.

### BACKGROUND

The field of the invention relates generally to a dispensing appliance for dispensing a powdered beverage, and more particularly to such an appliance that dispenses a predetermined quantity of powdered beverage. The appliance may mix the powdered beverage with liquid prior to or during dispensing.

Powdered infant/toddler formulas, energy drinks, soft drinks and other powdered beverages are typically mixed with a liquid (e.g., water or milk) to produce a consumable beverage in liquid form. To prepare the end product, the powdered beverage is scooped from its packaging, such as by a scoop provided with the packaging or by a suitable measuring spoon or cup and loaded into a suitable container. The liquid to be mixed with the powdered beverage may be provided in the container prior to the powdered beverage being loaded therein, or the liquid may be added to the container after the powdered beverage. The mixture is then stirred, or the entire container shaken, to mix the powdered beverage with the liquid to form the end product.

To this end, dispensing machines and appliances have been produced in an effort to automate the dispensing process. For example, in one known appliance in which infant formula is mixed with water to produce a ready-to-feed end product, the infant formula is contained in a hopper that includes a metering screw at a bottom of the hopper for dispensing the formula through an outlet. The infant formula must be transferred from its packaging into the hopper, such as by pouring the formula directly into the hopper. This transfer step may be cumbersome for the user because packaging is typically not designed for pouring the formula out of the packaging. Moreover, the cleanability of the hopper and the ability to maintain a sanitary environment for the powdered formula therein can be difficult.

### SUMMARY

In one aspect, a dispensing appliance for dispensing a beverage from a container of powdered beverage generally comprises a housing having an interior space and an exit through which beverage is dispensed from the housing. A dispenser is connectable to the container with the dispenser interfacing with the powdered beverage in the container. The dispenser is positionable between a blocking position in which powdered beverage is inhibited against dispensing from the container, and a dispensing position in which powdered beverage is dispensed from the container. The dispenser is releasably securable at least one of on and within the housing to permit removal of the dispenser from the housing. A drive system is configured for operative connection with the dispenser to operate the dispenser to dispense powdered beverage from the container.

In another aspect, a dispensing appliance for dispensing a beverage generally comprises a cartridge comprising a container containing powdered beverage, and a dispenser on the container operable to dispense powdered beverage from the container. A mount removably supports the cartridge on the dispensing appliance. A drive system is configured for operative connection with the dispenser upon loading of the cartridge into the mount, and is operable to operate the dispenser to release powdered beverage from the container.

In another aspect, a method of refilling a dispensing appliance for powdered beverage generally comprises dismounting a first cartridge from a mount of the dispensing appliance, wherein the cartridge includes a substantially empty container of powdered beverage and a dispenser secured thereto. The dispenser of the first cartridge is disconnected from a drive system of the dispensing appliance. A second cartridge is mounted on the mount of the dispensing appliance after dismounting the first cartridge and disconnecting the dispenser from the drive system, wherein the second cartridge includes a new, substantially full container of powdered beverage and a dispenser secured thereto. The dispenser of the second cartridge is operatively connected to the drive system of the dispensing appliance.

### BRIEF DESCRIPTION OF THE DRAWINGS

FIG. 1 is a top perspective of a first embodiment of a dispenser for dispensing a dose of powdered beverage;

FIG. 2 is a bottom perspective of the dispenser;

FIG. 3 is an exploded view of FIG. 2, illustrating a first embodiment of a dispenser body, a first embodiment of a metering disk, and a first embodiment of an agitator;

FIG. 4 is a bottom plan view of the dispenser;

FIG. 5 is a top plan view of the dispenser;

FIG. 6 is a cross-sectional view of the dispenser taken in a plane defined by a line 6-6 in FIG. 4;

FIG. 7 is similar to FIG. 6 except it includes only the body of the dispenser;

FIG. 8 is a top plan view of a metering disk of the dispenser;

FIG. 9 is a top perspective of a second embodiment of the metering disk;

FIG. 10 is a top perspective of a third embodiment of the metering disk;

FIG. 11 is an exploded perspective of one embodiment of packaging for a powdered beverage with a tear strip of a packaging collar being removed therefrom;

FIG. 12 is a perspective of the packaging of FIG. 11 with a dispenser disposed on the container in place of the closure initially disposed on the container;

FIG. 13 is a perspective of a second embodiment of packaging for a powdered beverage illustrating a dispenser hingedly secured to a container of the packaging;

FIG. 14 is a bottom plan view of the dispenser including a second embodiment of an agitator and the second embodiment (FIG. 9) of the metering disk;

FIG. 15 is a perspective of a third embodiment of an agitator;

FIG. 16 is a schematic representation depicting the packaging interfacing with the dispensing appliance and representing the components of the dispensing appliance;

FIG. 17 is a perspective of one embodiment of a dispensing appliance with the packaging and dispenser of FIG. 12 being inserted into the dispensing appliance;

FIG. 18 is a bottom perspective of a second embodiment of the dispenser including a second embodiment of the dispenser body and with the agitator removed;

FIG. 19 is similar to FIG. 18 but with the metering disk removed from the dispenser body;

FIG. 20 is a bottom perspective of a third embodiment of the dispenser including a cover flap component;

FIG. 21 is similar to FIG. 20 but with an agitator removed;

FIG. 22 is similar to FIG. 21 but with the cover flap component also removed;

FIG. 23 is a bottom perspective of the agitator;

FIG. 24 is a top perspective of a fourth embodiment of the dispenser;

FIG. 25 is a top plan view of the dispenser;

FIG. 26 is a cross section of the dispenser taken in a plane defined by a line 26-26 in FIG. 25;

FIG. 27 is similar to FIG. 26 but with a metering member removed from the dispenser;

FIG. 28 is a top plan view of a metering member of the dispenser of FIG. 26;

FIG. 29 is a bottom perspective of the metering member;

FIG. 30 is similar to FIG. 25 but with a collar component of the dispenser being transparent;

FIG. 31 is a top perspective of the dispenser similar to FIG. 24 but with a collar component removed therefrom;

FIG. 32 is similar to FIG. 30 but with the metering member removed from the dispenser;

FIG. 33 is a schematic illustration of a third embodiment of a dispensing appliance;

FIG. 34 is a top perspective of another embodiment of packaging for a powdered beverage;

FIG. 35 is a bottom perspective of the packaging of FIG. 34 with a dispenser disposed on the packaging;

FIG. 36 is an exploded top perspective of the packaging of FIG. 34 and the dispenser of FIG. 35;

FIG. 37 is a top perspective of an inner dispensing member of the dispenser of FIG. 36;

FIG. 38 is a bottom perspective thereof;

FIG. 39 is a top perspective of an outer dispensing member of the dispenser of FIG. 36;

FIG. 40 is a bottom perspective thereof;

FIG. 41 is a fragmented vertical section of the packaging and dispenser of FIG. 34;

FIG. 42 is a side elevation of the packaging of FIG. 34 supported by a mount for mounting the packaging in an dispensing appliance;

FIG. 43 is a fragmented vertical section of the packaging and mount of FIG. 42;

FIG. 44 is a top perspective of the mount of FIG. 42;

FIG. 45 is a vertical section thereof;

FIG. 46 is a top plan view of the mount of FIG. 42;

FIG. 47 is a top plan view of the packaging and dispenser supported by the mount of FIG. 42, with the bottom of the packaging removed and the packaging void of powdered beverage;

FIG. 48 is a top perspective of the packaging for powdered beverage, with another embodiment of a dispenser disposed on the packaging and with the packaging and dispenser supported by another embodiment of a mount for mounting the packaging in a dispensing appliance;

FIG. 49 is an exploded top perspective of the packaging and dispenser of FIG. 48;

FIG. 50 is a top perspective of an inner dispensing member of the dispenser of FIG. 49;

FIG. 51 is a bottom perspective thereof;

FIG. 52 is a top perspective of an outer dispensing member of the dispenser of FIG. 49;

FIG. 53 is a bottom perspective thereof;

FIG. 54 is a fragmented vertical section of the packaging, dispenser and mount of FIG. 48;

FIG. 55 is a fragmented bottom perspective of the packaging, dispenser and mount of FIG. 48;

FIG. 56 is a top plan view of the packaging, dispenser and mount of FIG. 48 with a bottom of the packaging removed and the packaging void of powdered beverage;

FIG. 57 is a fragmented vertical section of another embodiment of a packaging and dispenser;

FIG. 58 is an enlarged perspective of an agitator for use with the inner dispensing member of FIG. 37; and

FIG. 59 is an enlarged side elevation of thereof.

### DETAILED DESCRIPTION OF THE DRAWINGS

In one aspect, the present disclosure is directed generally toward a dispenser that is removably or non-removably secured to or adapted to be removably or non-removably secured to packaging of powdered beverage. As used herein, the term powdered beverage means a beverage substance that is in the form of particulates, which may be fine or granular or any combination thereof. The powdered beverage is suitably of the type commonly used as a premix that is mixed with a liquid to form an end-product beverage. For example, the packaging may contain powdered milk formula or other nutritional formula for infants (e.g., children under the age of twelve), follow-on formula (e.g., for children between six months and thirty-six months), nutritional formulas for toddlers, nutritional formulas or supplements for adults, pediatric formulas, nutritional formulas for medical purposes, nutritional sports drinks, energy drinks, powdered protein, or any other powdered beverage that mixes with a liquid to make an end product beverage mixture. The packaging may instead contain other non-nutritive powdered beverages such as flavored drinks, fruit punch, and the like. As will be discussed in more detail below, it is envisioned that the packaging with the dispenser secured thereto may be used as a replaceable cartridge that is interfaced with a dispensing appliance or other device to automatically dispense a selected amount (i.e., a selected dose) of powdered beverage. In general, the dispenser may be of any type or configuration capable of interfacing with the dispensing appliance and dispensing powdered beverage.

In another aspect, the present disclosure is directed toward embodiments of the dispenser, and more specifically, toward a dispenser comprising a rotatable metering member that is configured to rotate about an axis to dispense metered quantities of powdered beverage from a container. In this aspect, the dispenser may be removably or non-removably secured to or adapted for removable or non-removable securement to packaging or to a container that is separate from the packaging (e.g., a component of the dispensing appliance), or the dispenser may be a removable or non-removable component of the dispensing appliance.

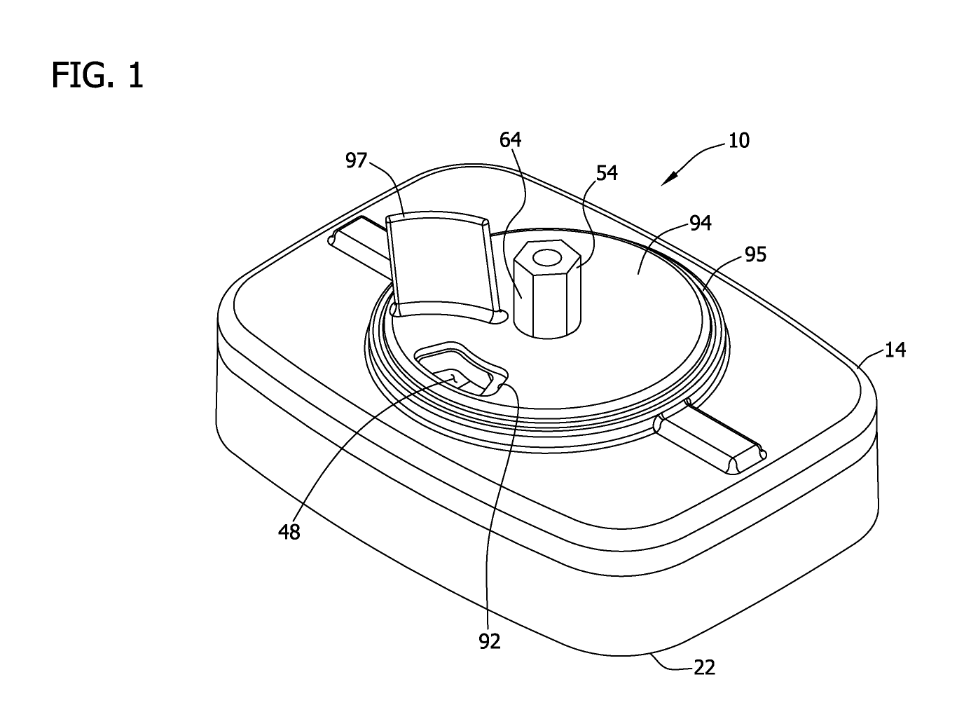

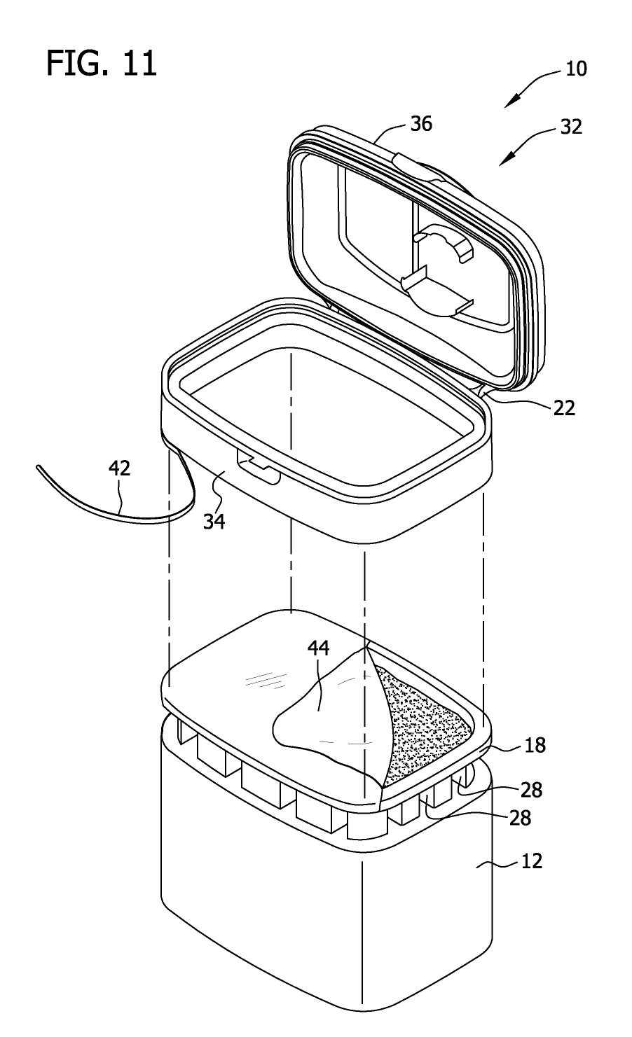

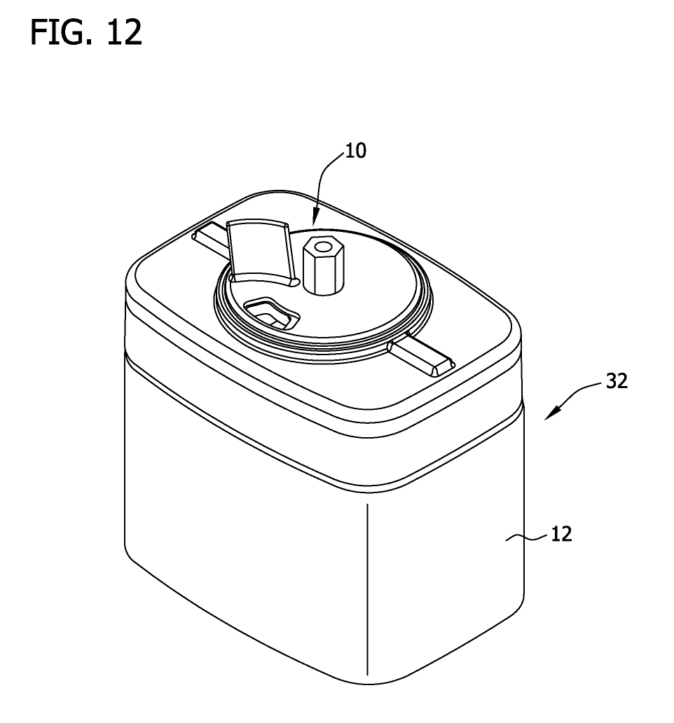

Referring to FIGS. 1-10, a first embodiment of a dispenser adapted for attachment to packaging of powdered beverage is generally indicated at 10. In general, the illustrated dispenser 10 is adapted to be secured to a container 12 (FIGS. 11 and 12) of the packaging so that the dispenser can dispense selected amounts (i.e., doses) of the powdered beverage from an interior space of the container. The dispenser 10 generally includes a body 14 and a dispensing member 16 in the body. The illustrated dispensing member 16 comprises a rotatable metering member. However, it is understood that the dispensing member 16 may be of other means for dispensing doses of the powdered beverage, such as a gate valve or a metering screw, without departing from the scope of the present invention. The dispenser body 14 in the illustrated embodiment is adapted for securement to the container 12 (FIGS. 11 and 12) having a generally rectangular top or rim 18 with round corners. In particular, the dispenser body 14 includes a securement portion in the form of a securement collar 22 depending from the body adjacent to a perimeter of the body. The securement collar 22 has a generally rectangular interior surface 24 that is sized and shaped for seating around the generally rectangular rim 18 of the illustrated container. The securement portion may be configured for seating on the rectangular rim. Moreover, the securement portion may be of other shapes and configurations depending on the container to which it is configured to be secured. It is also envisioned that the securement collar 22 may be a component of the container 12, and the dispenser body 14, including the dispensing member 16, may be removably securable to the collar, such as by snap-fit fasteners or other types of fasteners.

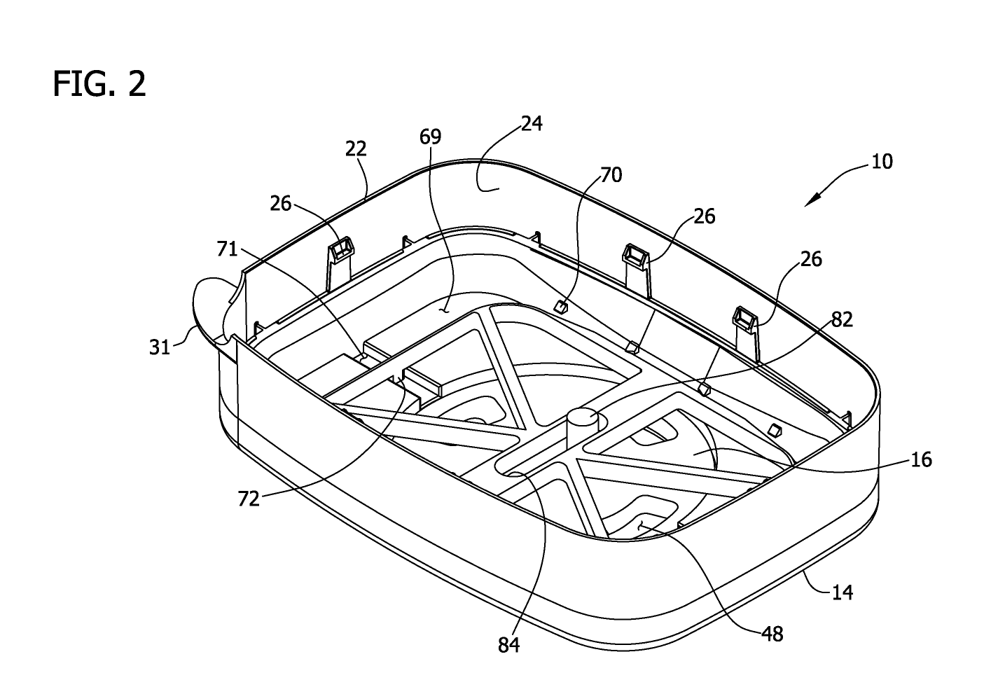

The securement collar 22 includes first fastening components 26 (FIGS. 2-5), such as snap-fit elements, latch or hook elements, or press-fit fasteners, on the interior surface 24 of the securement collar. The first fastening components 26 releasably engage mateable second fastening components 28, such as snap-fit openings or undercuts (as illustrated) on the container 12 to removably secure the dispenser 10 to the container. The illustrated first fastening components 26 comprise cantilevered latch or hook elements, although it is understood that other types of fasteners and fastening components may be used without departing from the scope of the present invention. It is envisioned that the illustrated dispenser 10 may be a reusable dispenser that can be removed from the container 12 (e.g., when the container is empty) and attached to another identical container filled with powdered beverage. In the illustrated embodiment, the dispenser body 14 includes a tab 31 (e.g., a thumb tab) to facilitate removing the dispenser 10 from the container. The illustrated tab 31 projects laterally outward from the securement collar 22 and allows a user to pull upward on the tab with sufficient force to disengage the first fastening component 26 from the container 12. The dispenser 10 may include other components or devices to facilitate removal of the dispenser 10 from the container 12 without departing from the scope of the present invention.

Referring to FIGS. 11 and 12, one example of packaging that includes the container 12 to which the illustrated dispenser may be secured is generally indicated at 32 (FIG. 11). Such packaging 32 is a modified version of the SimplePac™ packaging available from Abbott Nutrition of Columbus, Ohio. The illustrated packaging 32 includes the container 12, a packaging collar 34 secured around the rim 18 of the open top of the container, and a lid 36 hingedly secured to the packaging collar for opening and closing the container. The snap-fit openings 28 (e.g., undercuts) in the container 12 receive deflectable snap-fit hooks (not shown) on an interior surface of the packaging collar 34. The packaging 32 also includes a removable peel-strip 42 (FIG. 11) secured to the packaging collar 34 along a line of weakness extending around the collar. The peel-strip 42 is configured to inhibit the snap-fit hooks from disengaging the snap-fit openings 28 (i.e., inhibits upward movement of the collar and lid relative to the container). For example, the peel-strip 42 may be formed over a flange (not shown) or other structure of the container 12. The peel-strip 42 can be removed (i.e., peeled or broken away) along the line of weakness, thereby allowing a user to remove the lid 36 and collar 34 collectively as a unit from the container 12 by pulling upward on the collar to disengage the snap-fit hooks from the container. After removing the packaging collar 34 and the attached lid 36 from the container 12, the dispenser 10 can be removably secured to the container by positioning the dispenser on the rim 18 of the container (FIG. 11) so that the latches or hooks 26 (FIG. 2) releasably engage the container 12. As shown in FIG. 11, the packaging 32 may include a removable closure or seal 44 (e.g., a foil seal) secured over the rim 18 or top of the container 12. The seal 44 is peeled off, or opened, or punctured, or otherwise removed before attaching the dispenser 10 to the container 12.

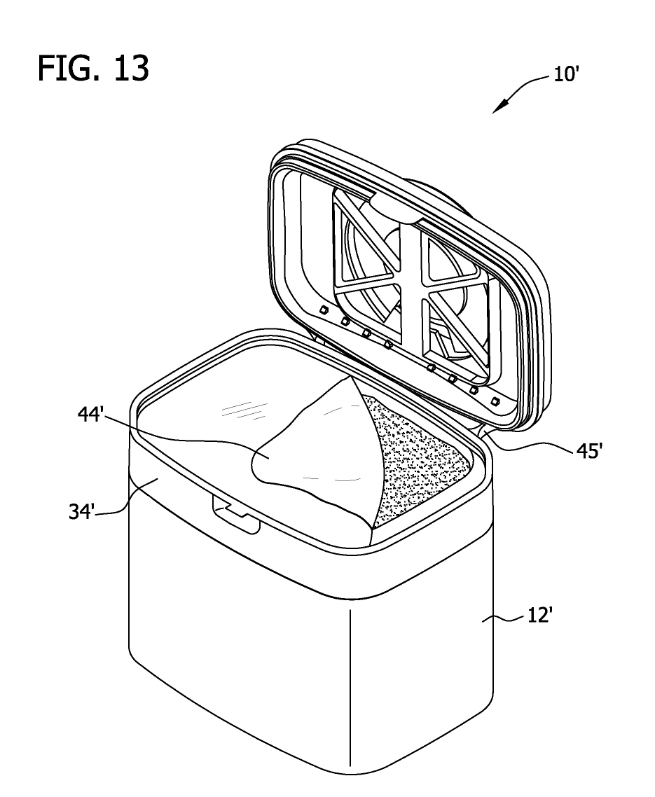

Referring to FIG. 13, in another example, a dispenser, generally indicated at 10′, is configured for hinged securement to a container 12′ as illustrated. In this example, the dispenser 10′ is interchangeable with the hinged lid (not shown) on the container 12′, which is similar to the hinged lid 36 in FIG. 11. In one example, a consumer may remove the lid 36 from the collar 34′ at a hinged connection (similar to hinged connection 45 illustrated in FIG. 11) and then hingedly secure the dispenser 10′ to the container 12′. In this example, it is envisioned that the dispenser 10′ is a reusable device that may initially be (i.e., at the time of purchase) separate from the packaging of powdered beverage. In another example, the packaging of powdered beverage may be offered for sale with the hinged dispenser 10′ secured thereto. In this example, the dispenser 10′ may be discarded (i.e., recycled or thrown away) with the empty container 12′ (i.e., after all of the powdered beverage is dispensed from the container). In both examples, the packaging may include a conventional metering scoop (not shown) typically included with conventional packaging so that the user can dispense the powdered beverage from the container 12′ either by pivoting the dispenser 10′ on the packaging to open the container and using the scoop, or by using the dispenser 10′, such as with a dispensing appliance.

In the illustrated embodiment (FIG. 13), the dispenser 10′ includes a hinged fastener similar to the hinged fastener on the lid to hingedly fasten to the container 12′ at a hinged connection 45′. Moreover, the dispenser 10′ includes fasteners (e.g., snap-fit fasteners) that removably secure the dispenser over the top of the container (e.g., the packaging collar) so that the dispenser also functions as the lid of the container. The fasteners on the dispenser 10′ may be similar in structure and function to fasteners on the lid that engage the packaging (e.g., fasteners that engage the packaging collar). As shown in FIG. 13, the packaging may include a removable seal 44′ (e.g., a foil seal) secured over the top of the container 12′. The seal 44′ is peeled off, or opened, or punctured or otherwise removed.

The packaging may be of other configurations for attaching the dispenser thereto. For example, the packaging may not include the packaging collar and the lid, but instead may include the container and the seal over the access opening of the container. Other configurations of the packaging do not depart from the scope of the present invention.

Other ways of removably securing the dispenser 10 to the container 12 or another type of container do not depart from the scope of the present invention. For example, the dispenser 10 may include a collar or other component that is itself configured to be press-fit on the container, either in engagement with a collar, or in engagement with a body, or in engagement with any other component or part of the container or packaging. It is understood that the dispenser 10 may not include a collar that is securable around a top of a container without departing from the scope of the present invention. In one embodiment, the dispenser 10 may include a securement component(s) that is sized and shaped for reception in the top of the container and/or an opening defined by any packaging collar, as opposed to surrounding the top of the container, and may, for example, include fastening components, such as cantilever hooks, to removably secure the dispenser to the container.

Although the embodiments of the dispenser 10 disclosed above are configured to be removable from the packaging container, the dispenser may be configured to be non-removably secured to the container without departing from the scope of the present invention. For example, in any one of the above embodiments and others disclosed later herein, fasteners on the collar and the container and or the collar and the container themselves may be configured to non-removably attach the dispenser to the container. In another example, the dispenser may be heat welded to the dispenser or secured to the dispenser by adhesive. Other ways of non-removably securing the dispenser to a container—not limited to the illustrated container or to a container that includes a collar—do not depart from the scope of the present invention. It is envisioned that in the embodiments where the dispenser is non-removably secured to the container, the container may be sold with the dispenser either attached to it (i.e., as a unit) or as a single product with the dispenser not yet attached to it (i.e., packaged together but not attached). It is also envisioned that the container and the attached dispenser will be disposed of together (i.e., recycled or thrown away) after the powdered beverage is dispensed from the container.

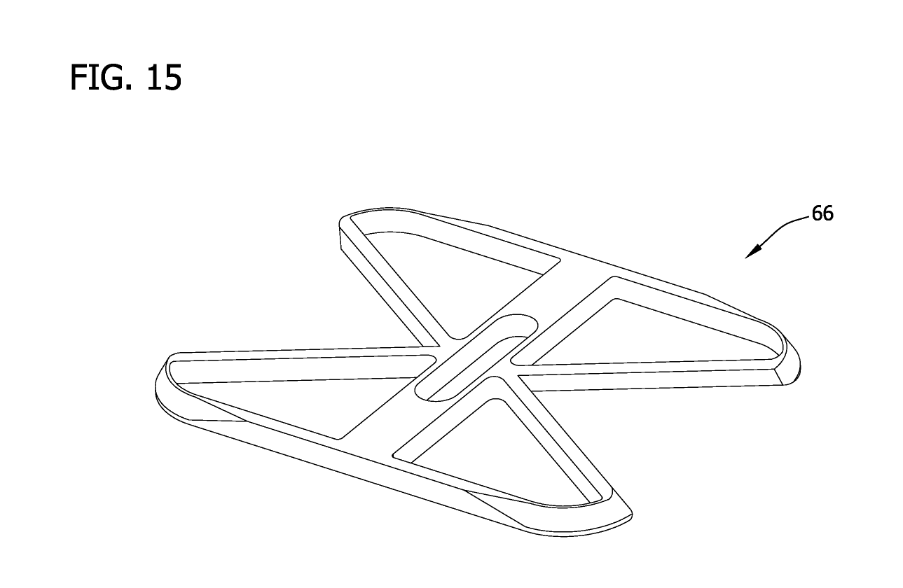

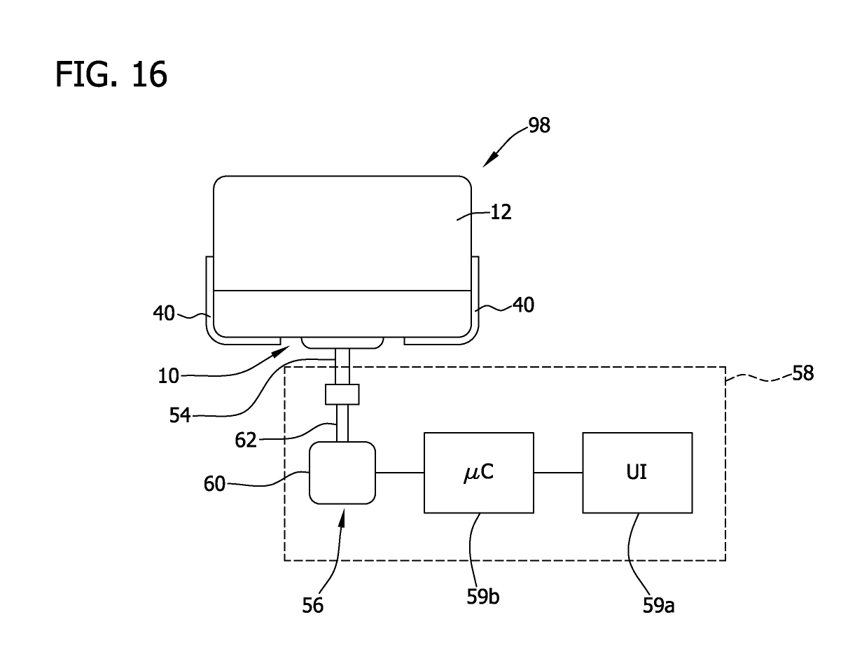

Referring to FIG. 16, it is envisioned that packaging, generally indicated at 98, comprising a container with a dispenser secured thereto, such as the container 12 and the dispenser 10 or any other container and dispenser, functions as a replaceable cartridge of powdered beverage for a dispensing appliance 58. The illustrated appliance is configured for dispensing of the powdered beverage, dispensing of liquid, and mixing the dispensed powdered beverage with the liquid. It is understood, however, that the appliance may be configured to only dispense powdered beverage and/or may not be configured for mixing, without departing from the scope of the present invention. In general, the dispensing appliance 58 is configured to automatically operate the dispenser 10 to dispense a selected quantity of powdered beverage from the packaging 98. The dispensing appliance 58 in one embodiment may comprise a mount 40 (illustrated schematically in FIG. 17) on which the packaging 98 can be positioned so that the dispenser 10 interfaces with a suitable drive system 56 of the dispensing appliance. The mount 40 may comprise a bracket or other device that secures the packaging 98 in the dispensing appliance 58. The mount 40 may be located in an enclosure 99 of the dispensing appliance 58 so that the packaging 98 is inserted into the enclosure to mount the packaging 98 in the appliance but is otherwise concealed during use. Operation of the dispensing appliance 58 for use with the illustrated dispenser is explained in more detail later herein.

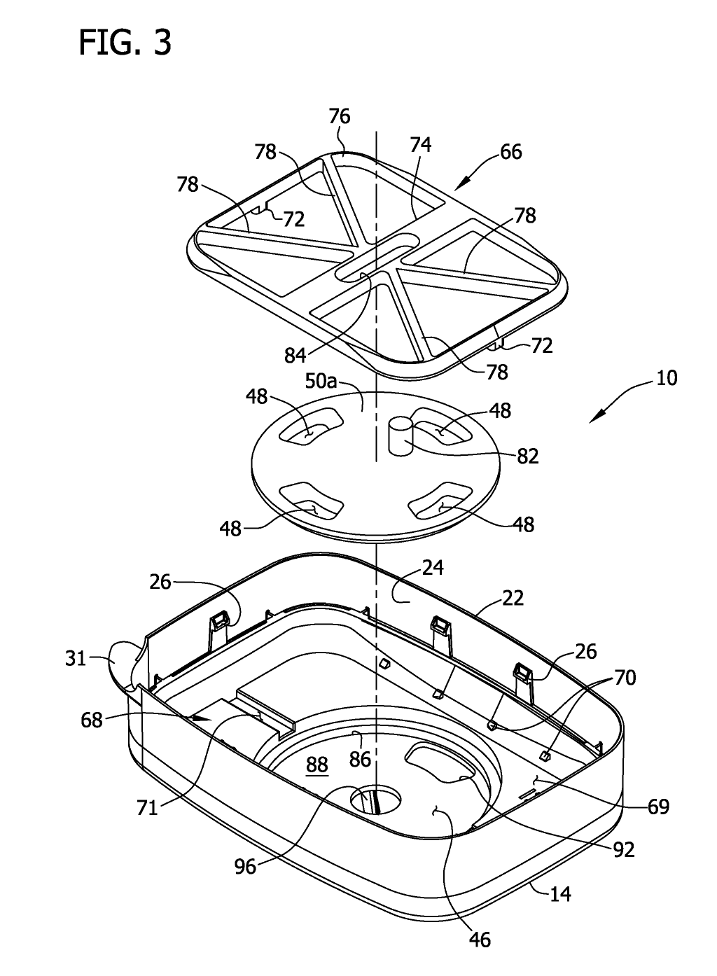

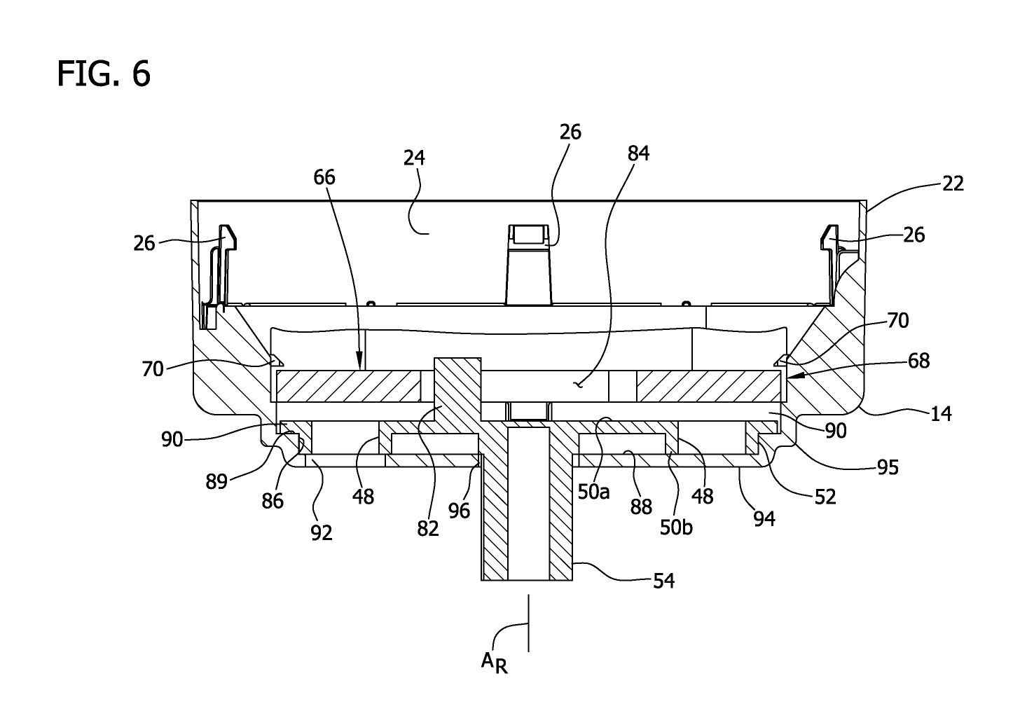

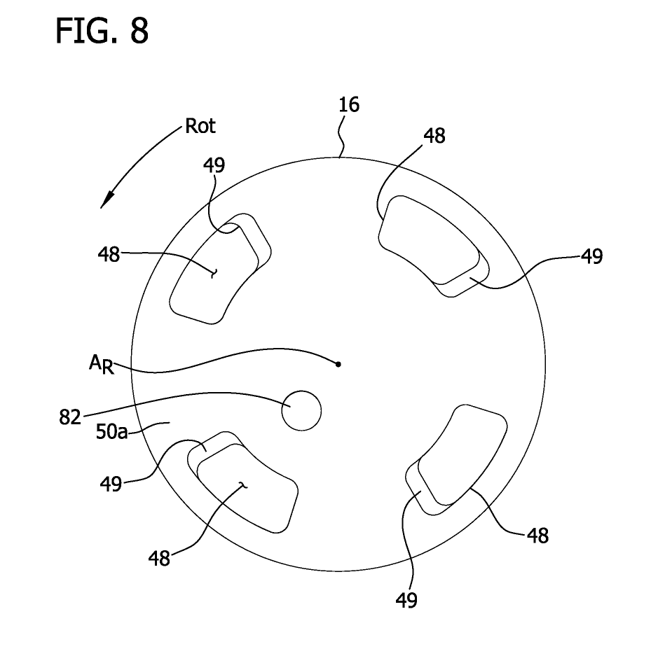

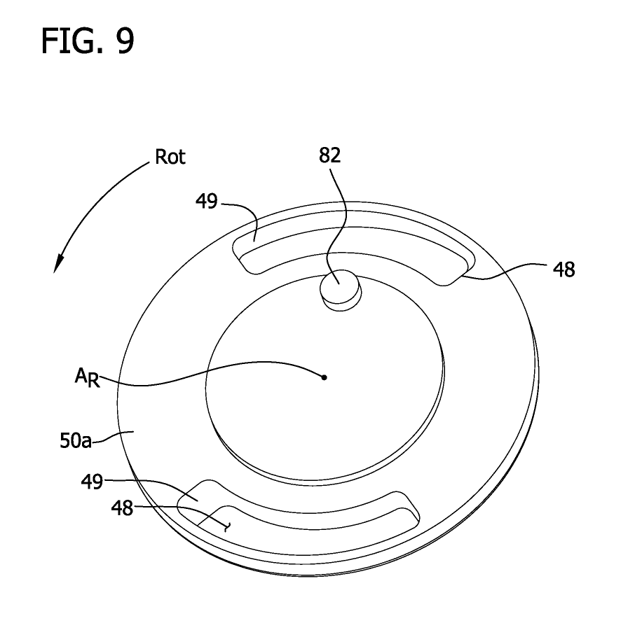

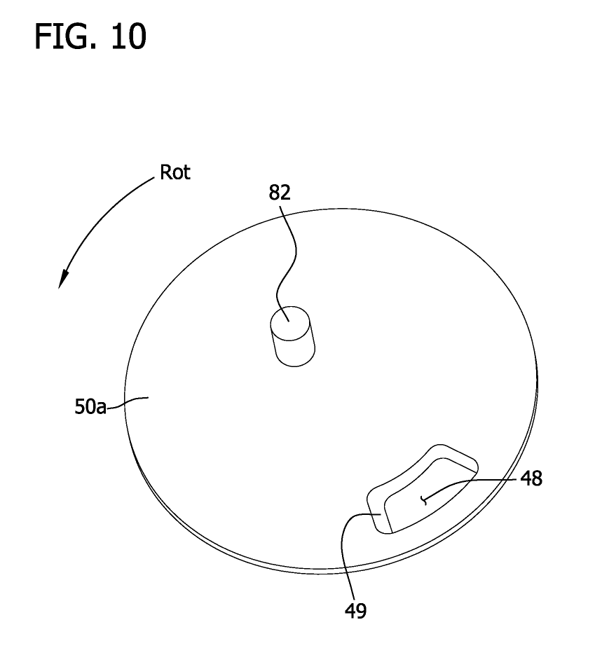

Referring to back FIGS. 1-8, the dispensing member 16 in the illustrated dispenser 10 is in the form of a metering disk rotatably secured in a bearing recess 46 defined by the dispenser body 14. As seen best in FIGS. 3 and 8, the metering disk 16 defines four metering cavities 48 extending through opposite first and second faces 50a, 50b of the disk. It is understood that the metering disk 16 may define less than four metering cavities (e.g., one, two or three metering cavities) or more than four metering cavities without departing from the scope of the present invention. For example, the metering disk 16 may define two diametrically opposite metering cavities 48, as shown in FIG. 9. In another example, the metering disk 16 may define a single metering cavity 48, as shown in FIG. 10. Referring to FIG. 8, the metering cavities 48 are spaced at equal intervals around a center of the disk (e.g., 90 degree intervals in the illustrated embodiment). Each metering cavity 48 in the illustrated embodiment is generally shallow and has a longitudinal axis extending along a generally arcuate path that is substantially concentric with the metering disk 16. In one example, a depth of each cavity 48, extending between the opposite faces 50a, 50b, may suitably be less than about 12 mm, more suitably within a range between about 2 mm and about 12 mm, and even more suitably between about 4 mm and about 6 mm. The metering cavities 48 may have other shapes and configurations (see FIGS. 9 and 10, for example), and may also extend through a lateral surface 52 or periphery of the metering disk 16 without departing from the scope of the present invention. As described in more detail below, the metering disk 16 is rotatable a full 360 degrees within the bearing recess 46 about a rotation axis A_{R} (FIG. 6) that passes through the center of the metering disk 16 and a center of the bearing recess.

In one embodiment (seen best in FIG. 8), a trailing edge 49 of each metering cavity 48 is chamfered from the first face 50a to the second face 50b. The chamfered trailing edge 49 facilitates metering and dispensing of the powdered beverage as the metering disk 16 rotates in the direction ROT (i.e., clockwise in FIG. 8). In another embodiment, an opposite leading edge of each metering cavity may also be chamfered from the second face 50b to the first face 50a. Each metering cavity 48 may have other configurations without departing from the scope of the present invention. It is also understood that while the metering cavities 48 of the illustrated disk 16 are of equal shape and dimension, the metering cavities may be of different shapes and/or dimensions without departing from the scope of the present invention.

Referring to FIG. 16, a drive coupling 54 secured to (e.g., formed integrally with in the illustrated embodiment) and projecting from the metering disk 16 (see also FIGS. 1 and 6) operatively connects the metering disk to a drive system 56 of the dispensing appliance 58 (FIGS. 16 and 17), for example, to automatically rotate the metering disk. The drive system 56 may include a device or mechanism that is part of the dispensing appliance 58. In a simple configuration (FIG. 16), the drive system 56 may include a motor 60 that imparts rotation to a drive shaft 62 that connects directly to the drive coupling 54. In another configuration, the drive system 56 may include a transmission mechanism (not shown) operatively connected to the drive coupling 54 that transmits torque from the drive shaft 62 to the coupling. Rotation of the drive shaft 62 imparts rotation of the metering disk 16 about its rotation axis A_{R}. In the illustrated embodiment (seen best in FIG. 1), the drive coupling 54 defines a stem 64 (e.g., a stem with a hexagonal cross-section) that is coaxial with the rotation axis A_{R} and is adapted to be removably received in a component of the drive system 56, such as a socket secured to the drive shaft 62. Other types of drive couplings and other ways of connecting the metering member 16 to the drive system 56 for imparting rotation of the metering member do not depart from the scope of the present invention. It is also envisioned that the dispenser 10 may be manually driven. For example, the drive coupling 54 may include a handle, lever, wheel or other component that can be operated by hand to impart rotation to the metering disk 16.

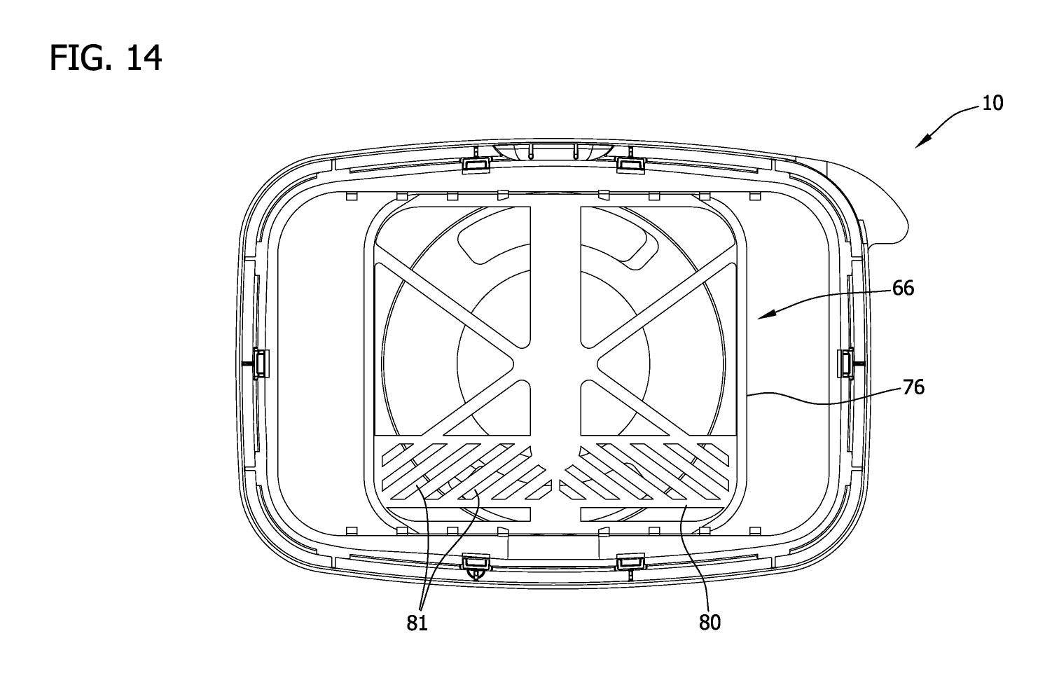

Referring to FIGS. 2-6, the dispenser 10 further includes therein an agitator (broadly, a powder flow promoting member) operatively connected to the metering disk 16. In particular, the illustrated agitator is slidably received in a guideway, generally indicated at 68, in the dispenser body 14. The guideway 68 is defined by a generally rectangular guideway recess 69 (FIGS. 2 and 3). Keeper detents 70 (broadly, keeper members) removably retain the agitator 66 in the guideway 68 and allow the agitator to slide in the guideway along a length of the dispensing body. The guideway 68 also includes grooves 71 in a floor of the guideway recess 69 that receive tabs 72 (FIG. 2) extending outward from the agitator 66. The agitator 66 includes a hub 74 and a generally square or rectangular wireframe 76 (such as a plastic wire frame) extending around the hub. Struts 78 extending between the hub 74 and the wireframe 76 reinforce the wireframe and rigidify the agitator 66. In the example illustrated in FIG. 14, the agitator 66 also includes a grate or sifter 80 extending between opposite sides of the wireframe 76. (In the illustrated embodiment, the metering disk is the same as the metering disk illustrated in FIG. 9, although it is understood that the metering disk may be of other configurations.) For reasons discussed below, the sifter 80 defines slots 81 (broadly, openings) that impede, but do not prevent, the flow of the powdered beverage therethrough. In one example, the slots 81 have widths that are between about 1.5 mm and about 4 mm. The sifter 80 may have other types of openings, besides slots, without departing from the scope of the present invention. Another example of a suitable agitator 66 is illustrated in FIG. 15.

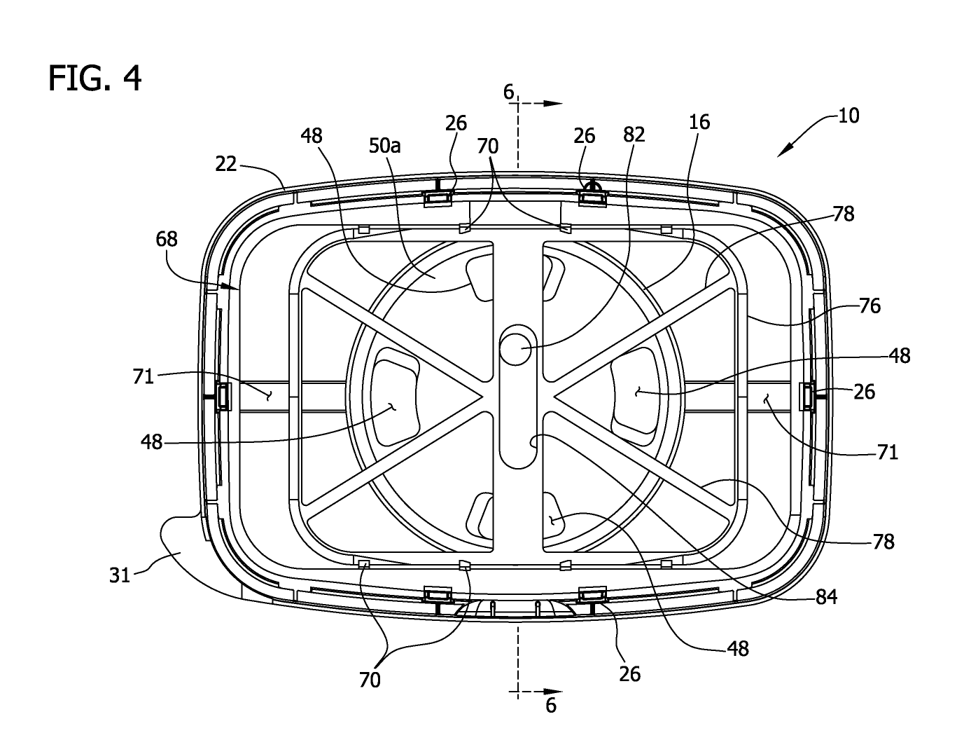

Referring still to FIGS. 2-6, the agitator 66 is operatively connected to the metering disk 16 through a lost motion connection for oscillating linear movement of the agitator between opposite longitudinal ends of the guideway 68. The metering disk 16 includes an agitator coupler 82 (e.g., a pin, as illustrated) extending outward from the first face 50a of the disk at a location offset radially from the rotation axis A_{R}. The agitator coupler 82 is slidably received in a slot 84 in the hub 74 of the agitator 66 (See, e.g., FIGS. 2 and 4). The slot 84 extends generally transverse to channels 70 of the guideway 68. In effect, the metering disk 16 and the agitator 66 function generally as a crank-slider mechanism with lost motion. As the metering disk 16 rotates in the bearing recess 46, the agitator coupler 82 imparts linear movement of the agitator 66 toward one of the opposite longitudinal ends of the guideway 68. When the agitator 66 reaches the longitudinal end of the guideway 68 and the metering disk 16 continues to rotate, the coupler 82 continues to move in the hub slot 84 without imparting linear movement. The metering disk 16 then reaches an angular position, at which time the coupler 82 drives the agitator toward the opposite longitudinal end of the guideway 68. Oscillating linear movement of the agitator facilitates declumping or breaking up of densely packed powder (i.e., bridging of powder, clumping or pucking of powder, etc.) that are adjacent to the metering cavities 48. In this way, the powdered beverage is capable of flowing more freely as individual particles, as opposed to large clumps, into the metering cavities 48. More accurate metering is achieved when the particles flow individually into the cavities 48 and not in clumps. Other ways of driving the agitator 66 do not depart from the scope of the present invention. Moreover, the dispenser may not include an agitator and remain within the scope of the present invention.

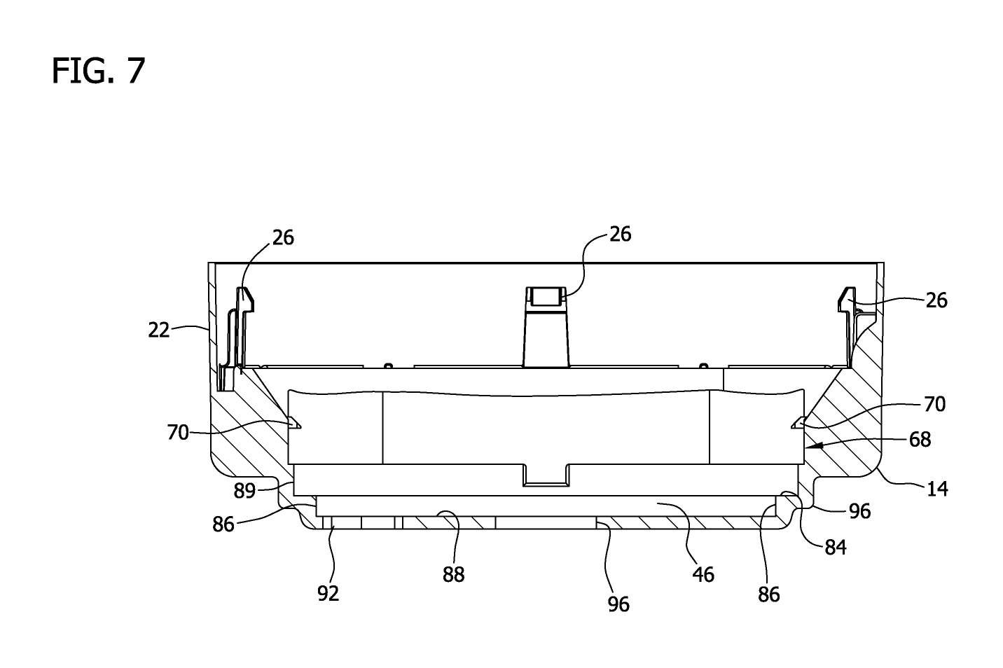

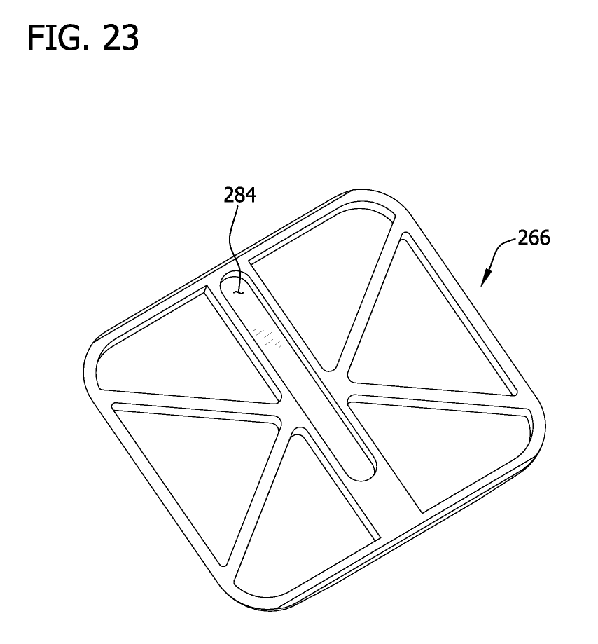

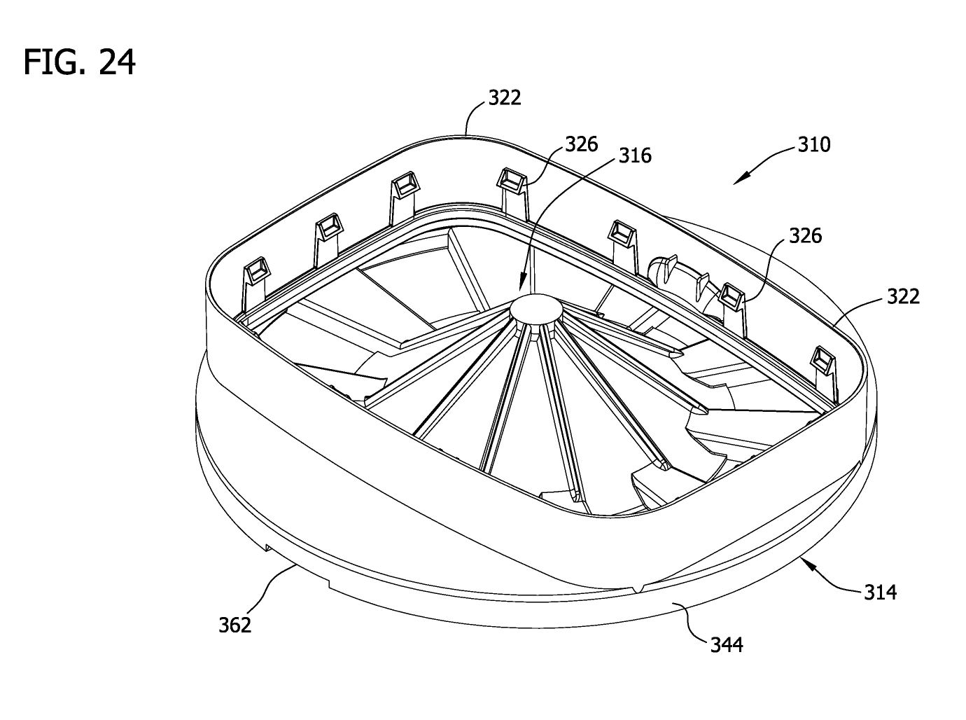

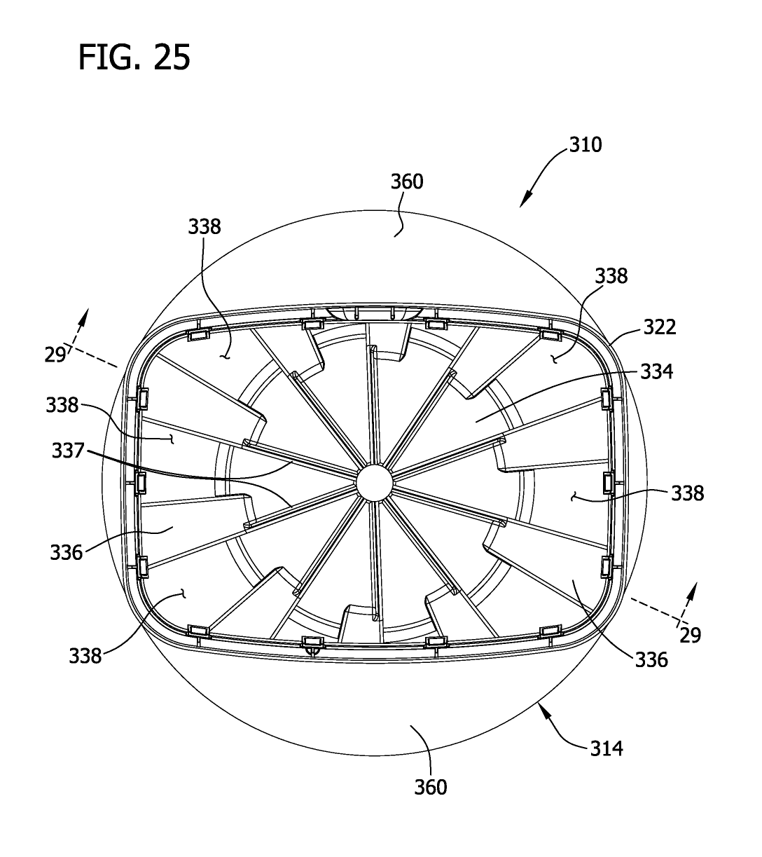

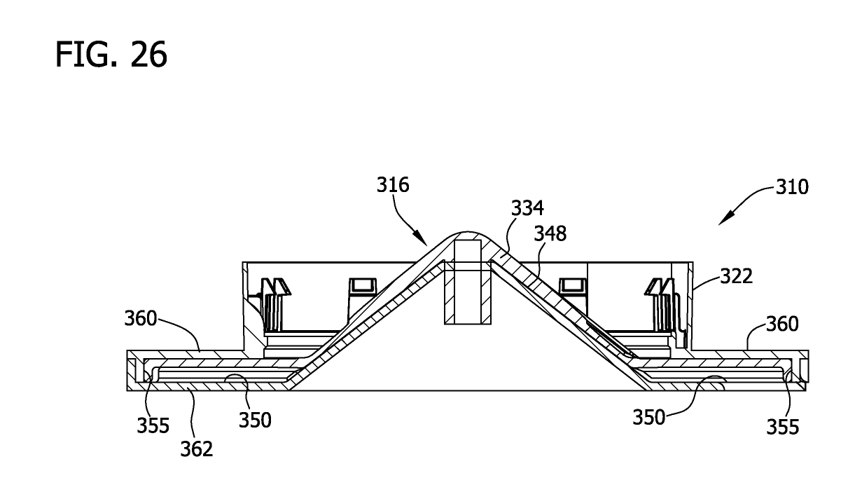

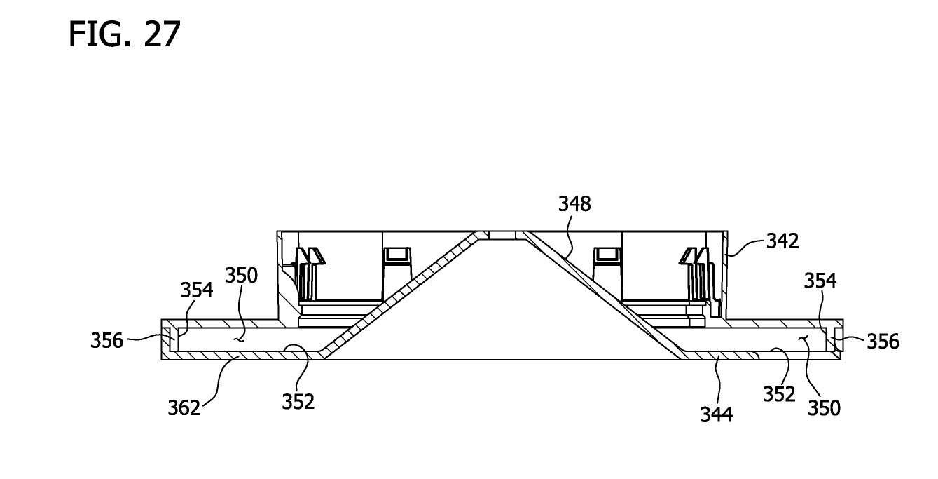

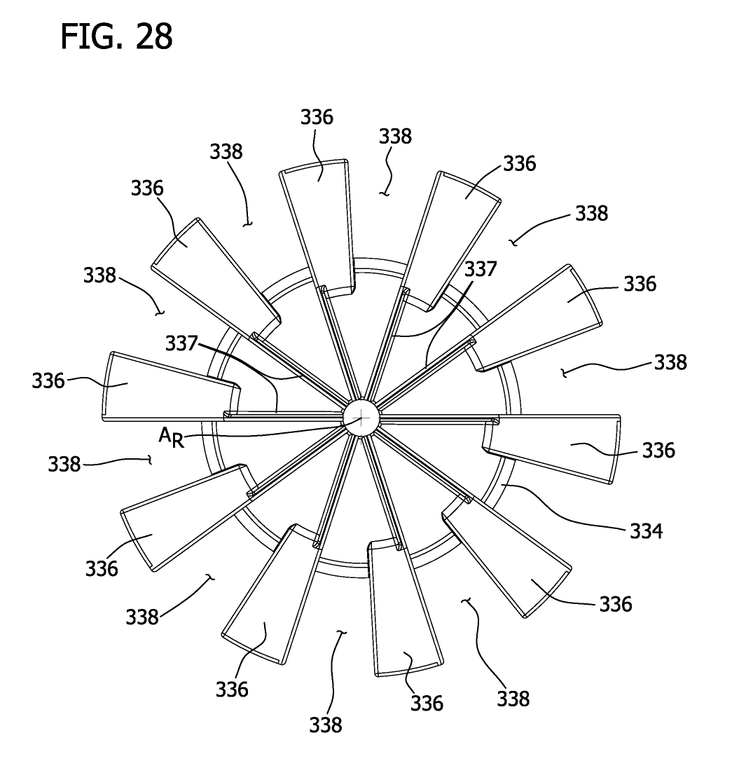

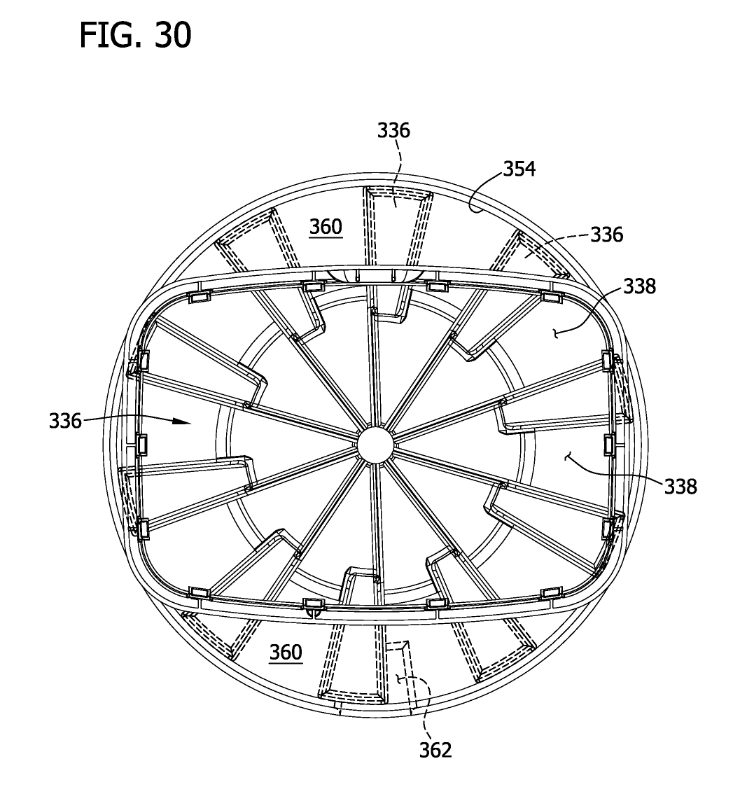

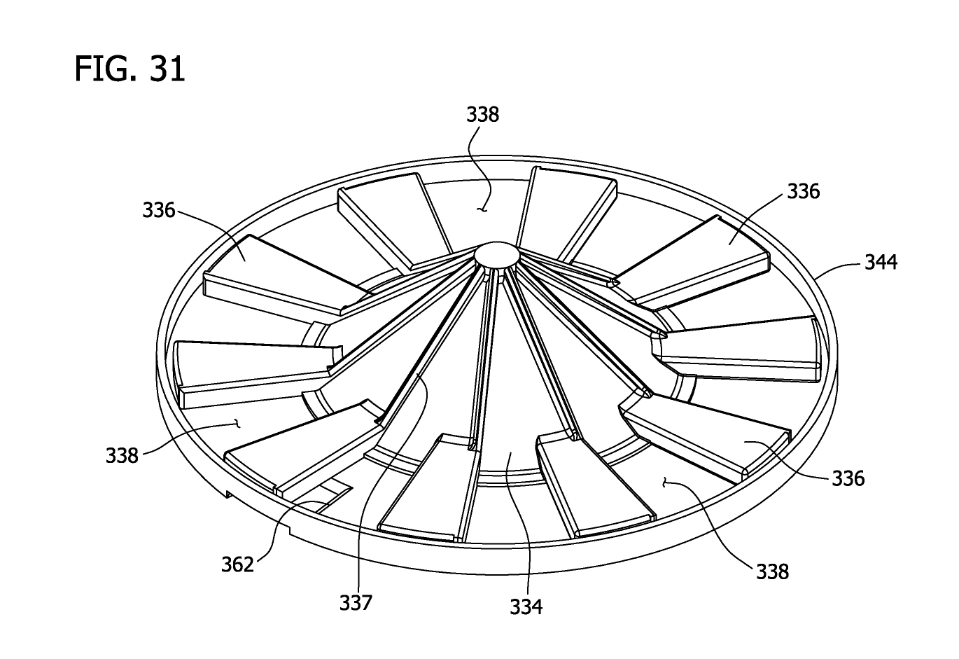

Referring to FIGS. 6 and 7, the bearing recess 46 is defined by a cylindrical bearing surface 86, which engages the lateral surface 52 of the metering disk 16, and an axial bearing surface 88 at an end of the cylindrical bearing recess 46, which slidably engages the second face 50b of the metering disk. In the illustrated embodiment, the bearing surfaces 86, 88 are plain bearing surfaces that are formed integrally as part of the body of the dispenser. It is contemplated that separate bearing components (not shown) may be secured to the dispenser body to define the bearing recess. An annular flange 89 at a radial edge of the bearing recess 46 defines a shoulder for seating an annular flange 90 of the metering disk 16 to inhibit powdered beverage from entering the bearing recess between the cylindrical bearing surface 86 and the metering disk. The bearing recess 46 of the illustrated dispenser 10 is entirely inside the generally rectangular perimeter of the body 12. It is understood, however, that the bearing recess 46 may extend outside the generally rectangular perimeter of the body (see, e.g., FIGS. 24-32).

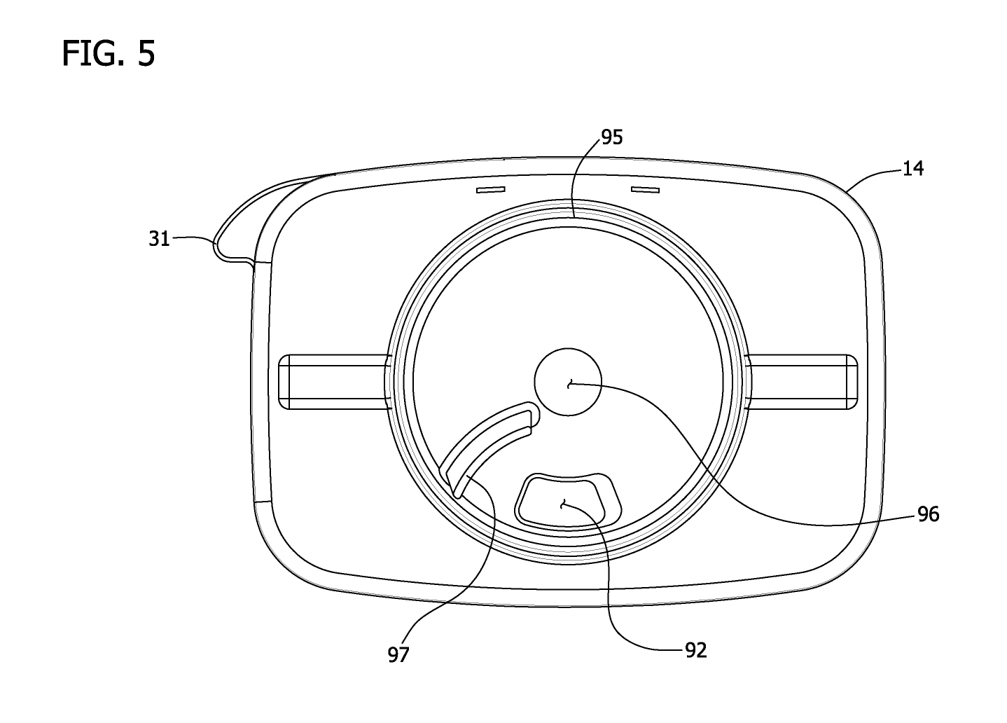

Referring to FIGS. 1, 3, 6 and 7, an exit opening 92 extends from the axial bearing surface 88 and through the dispenser body 14. As explained below, metered amounts of powdered beverage from the container 12 are dispensed through the exit opening 92. In the illustrated embodiment, the exit opening 92 extends through an axial end 94 of a generally cylindrical or cup-shaped end-panel 95 (e.g., a stepped cylindrical panel) that extends outward from the dispenser body 14 and is generally coaxial with the rotation axis A_{R}. In one suitable embodiment, the exit opening 92 has a shape that corresponds generally to the shape of each of the metering cavities 48, although a footprint of the exit opening is slightly larger than a footprint of the metering cavity. It is understood, though, that the exit opening 92 may be of another shape and/or size without departing from the scope of the present invention. The exit opening 92 is located at substantially the same radial distance from the rotation axis A_{R} as the metering cavity. The end-panel 95 also has a coupling opening 96 (FIGS. 5, 6 and 7) through which the coupling 54 extends. It is understood that the coupling 54 may not extend through the coupling opening 96, but instead, the coupling opening may be sized and shaped to receive a portion of the drive system to operatively connect the metering disk 16 to the drive system.

Referring to FIGS. 1 and 5, the dispenser body 14 in one embodiment also includes a deflector 97 projecting outward from the body generally adjacent to the exit opening 92 and suitably adjacent to the downstream end of the outlet in the direction of rotation of the metering disk 16. The deflector 97 comprises an elongate body having an arcuate cross-section. As explained below, the deflector 97 is adapted to direct the metered amount of powdered beverage exiting the exit opening 92 along a downward path. For example, in the illustrated embodiment, the deflector 97 is adapted to direct the powdered beverage along a path that is substantially parallel to the rotation axis A_{R}. The deflector 97 may be other configurations without departing from the scope of the present invention.

The dispenser body 14, the metering disk 16, and the agitator 66 are assembled together to form the dispenser 10. In one example, the dispenser components are removably attached to one another so that the assembled dispenser 10 can be easily disassembled for cleaning purposes. For example, in the illustrated embodiment, the keeper detents 70 removably retain the agitator 66 in the guideway 68, and the agitator, in turn, retains the metering disk 16 in the bearing recess 46. Other means of removably securing the components together to form a dispenser assembly do not depart from the scope of the present invention. The dispenser body 14 may be formed as a one-piece, integral structure, and the securement collar 34, the bearing recess 46, the bearing surfaces 86, 88, and the deflector 96 may be formed as part of the body. Each of the dispenser body 14, the metering disk 16, and the agitator 66 may be formed of a suitable plastic. For example, each of the components may be formed by any suitable molding technique. The components 14, 16, 66 may be formed of other material and may be formed in other ways without departing from the scope of the present invention.

Referring again to FIGS. 11-13, in use the closure or seal 44 may be removed from the packaging 32 and the dispenser 10, 10′ may be secured to the packaging to configure the packaging from a packaged configuration to a dispensing configuration. As explained above, the packaging 32 may be sold with a dispenser 10, 10′ already secured thereto, in which case the dispenser may need to be removed from the packaging in order to remove the closure or seal 44, whereupon the dispenser can be reattached to the packaging. With the packaging 98, which includes the dispenser 10, 10′, configured in the dispensing configuration, the packaging is turned upside down (i.e., inverted) and interfaced with the dispensing appliance 58. Referring to FIGS. 16 and 17, as explained above the dispensing appliance 58 may have the enclosure 99 that receives the packaging 98, and the mount 40 in the enclosure may secure the assembly in the enclosure. It is envisioned that the drive coupling 54 will connect to the drive system 56 of the dispensing appliance 58 upon inserting the packaging 98 in the dispensing appliance. With the packaging 98 properly interfaced with the dispensing appliance 58, the appliance can automatically dispense the powdered beverage from the container 12 by rotating the metering disk 16.

For purposes of the following description, initially each of the metering cavities 48 is filled with a metered quantity of powdered beverage from the container 12. A metering outlet of each metering cavity 48, which is defined by the second face 50a of the metering disk 16, is covered or closed by the axial bearing surface 88 so that each of the metering cavities retains the metered quantity of powdered beverage. Also, a metering inlet of each metering cavity 48, which is defined by the first face 50a of the metering disk, is open to the interior space of the container 12. Moreover, the metering disk 16 (i.e., a closed portion of the metering disk between adjacent metering cavities 48) covers and closes the exit opening 92 to prevent non-metered powdered beverage from exiting the dispenser 10. From this initial position (i.e., a metering position), the metering disk 16 is rotated about its rotation axis A_{R} to a dispensing position (see FIG. 4), whereby a first of the metering cavities 48 moves over the exit opening 92 (i.e., a portion of the metering cavity is in angular alignment with the exit opening) and is in registration or communication with the exit opening.

As the metering disk 16 rotates and the first metering cavity 48 moves over the exit opening 92, the metered quantity in the first metering cavity exits the metering cavity (e.g., by gravity in the illustrated embodiment) and is dispensed through the exit opening 92. The metering outlets of the other metering cavities 48 remain closed by the axial bearing recess 88. As the metering disk 16 continues to rotate to back to the metering position, the first metering cavity 48 moves past the exit opening 92 and over the bearing surface 88 so that the first metering cavity is again filled with the metered quantity of powdered beverage from the container 12. At the same time, the metering disk 16 (i.e., a closed portion of the metering disk between adjacent metering cavities 48) covers the exit opening 92 to prevent non-metered powdered beverage from exiting the dispenser 10. Continued successive rotation of the metering disk 16 from the metering position to the dispensing position angularly aligns a second one of the metering cavities 48 in communication with the exit opening 92 to dispense the metered quantity of powdered beverage from the second metering cavity. The second metering cavity 48 refills with powdered beverage as it moves past the exit opening 92. The metering disk 16 is rotated a selected angular amount and this process continues until an entire selected dose of powdered beverage is dispensed.

In one embodiment, it is envisioned that the dispensing appliance 58 may include a user interface 59a (FIGS. 16 and 17) in communication with a controller 59b (e.g., a microcontroller) to allow a user to select an amount of powdered beverage (e.g., grams) for dispensing. The dispensing appliance 58 may also allow a user to select an amount of liquid (e.g., fluid ounces) for dispensing. In one embodiment, the packaging includes dosage indicia indicating a dosage amount of powdered beverage for each quantity of liquid. For example, the dosage indicia on packaging of powdered infant formula may indicate mixing 17 grams of formula for every 4 fl. oz of warm water. In another embodiment, it is envisioned that the user interface 59a may allow a user to select the total amount of end product liquid beverage that the user wants dispensed (e.g., 4 fl. oz of liquid formula). In such an embodiment, the selected amount of the end product beverage will correspond to the target dose (i.e., a total dispensed quantity) of powdered beverage that needs to be dispensed from the container 12. For example, the microcontroller 59b may access a lookup table to determine the target dose for each quantity of end product selected (i.e., inputted). The controller 59b, in turn, is configured to dispense both the target dose of powdered beverage and the amount of liquid to make the selected quantity of end product liquid beverage mixture.

In yet another embodiment, a user may fill a reservoir with a selected amount of water (e.g., 4 fl. oz.), indicating the amount of end product beverage that the user wants made. In such an embodiment, the appliance 58 may include a liquid level sensor in the reservoir that communicates the quantity of liquid in the reservoir to the controller 59b. The controller 59b may access a lookup table to determine the target dose of powdered beverage corresponding to the sensed quantity of liquid. For example, a user who wants about 4 fl. oz of infant formula made will fill the reservoir with about 4 fl. oz of water. The liquid level sensor sends an electrical signal to the controller 59b that indicates there is about 4 fl. oz in the reservoir, and the controller determines, such as by a lookup table, that 17 grams of powdered infant formula needs to be dispensed. The controller 59b, in turn, dispenses both the 17 grams of powdered formula and the 4 fl. oz of water to make the end product infant formula.

The controller 59b dispenses the target dose of powdered beverage by controlling rotation of the metering disk 16. In one embodiment, the metering disk 16 may rotate at about 2.5 to about 3 revolutions/second and have a substantially constant rotation speed throughout dispensing. The amount of metered powdered beverage dispensed by a single metering cavity 48 (i.e., a capacity of each metering cavity) may be a fraction of a minimum target dose of powdered beverage that can be selected for dispensing. Using the above example, if the minimum amount of end product beverage that the dispensing appliance 58 can dispense is about 4 fl. oz, the corresponding minimum target dose of powdered beverage is 17 grams. Thus, the capacity of each metering cavity 48 may be some predetermined fraction of 17 grams. For example, the capacity or metered quantity of each metering cavity 48 may be ½ (e.g., about 8.5 grams) of the minimum target dose of powdered beverage, or ⅓ (e.g., about 5.67 grams), or ¼ (4.25 grams), etc. In one example, the capacity of each metering cavity 48 may be from about 1 gram to about 2 grams. It has been found that dispensing powdered beverage in metered amounts that are fractions of the target dose achieves a more accurate and precise dispensing of the target dose. It is understood, however, that the amount of metered powdered beverage dispensed by a single metering cavity 48 (i.e., a capacity of each metering cavity) may be equal to a minimum dose of powdered beverage that can be selected for dispensing.

The controller 59b is programmed to rotate the dispensing disk 16 a predetermined angular amount to dispense the total number of metered quantities corresponding to the target dose. For example, in the illustrated embodiment, 180 degree rotation of the metering disk 16 from the initial position dispenses two metered quantities; 270 degree rotation dispenses three metered quantities; 360 degree rotation dispenses four metered quantities; 450 degree rotation dispenses five metered quantities; and so on. Using the above example and the illustrated dispenser, if the capacity of each metering cavity 48 is ¼ of the minimum dose (e.g., 4.25 grams), the controller 59b may be programmed to rotate the metering disk 16 360 degrees (1 revolution) to dispense a minimum target dose of 17 grams to be mixed with 4 fl. oz of warm water. The dispensing appliance 58 may include a position sensing mechanism (not shown) in communication with the controller 59b so that the controller can detect the angular position of the metering disk 16 during dispensing.

In one example, depending on the rotational speed of the metering disk 16, the amount of powdered beverage actually dispensed as the metering cavity 48 passes over the exit opening 92 may be less than the capacity of the metering cavity due to the rotational speed of the disk. In another words, although the metering cavity 48 is substantially filled with powdered beverage as it passes over the exit opening 92, the metering cavity may not empty the entire quantity of powdered beverage because the rotational speed of the disk may not provide a sufficient amount of time for all of the powdered beverage to flow out of the metering cavity. The actual amount of powdered beverage that is dispensed per metering cavity 48 due to the speed of the metering disk 16 can be determined through empirical study to achieve accurate dosing of the beverage using the dispenser 10.

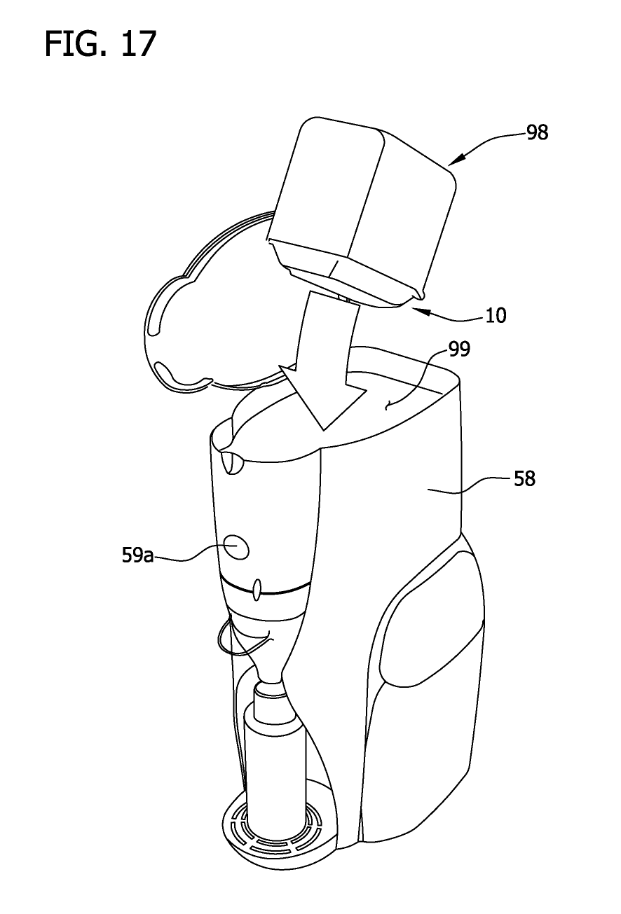

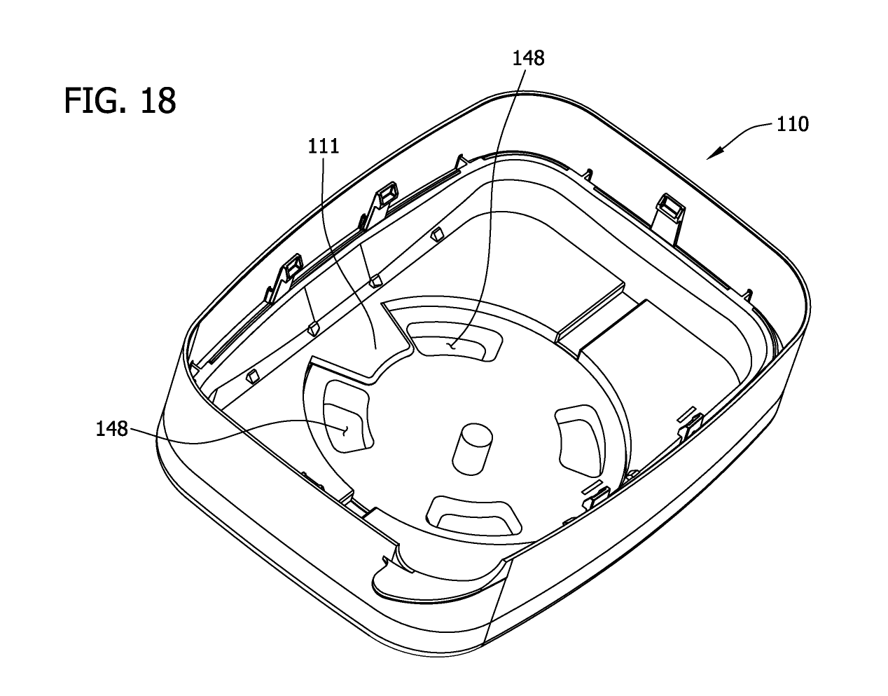

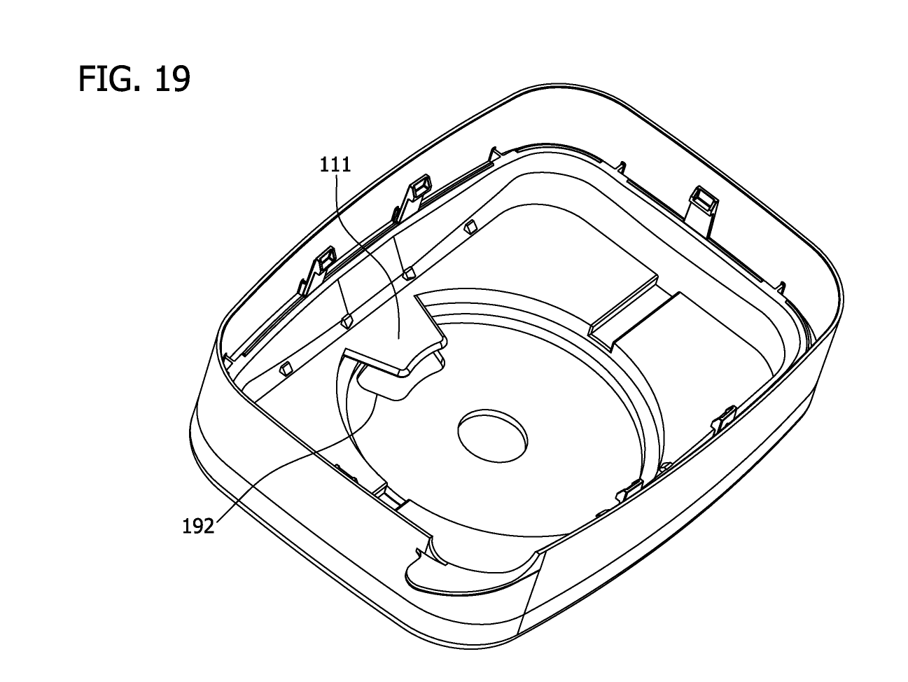

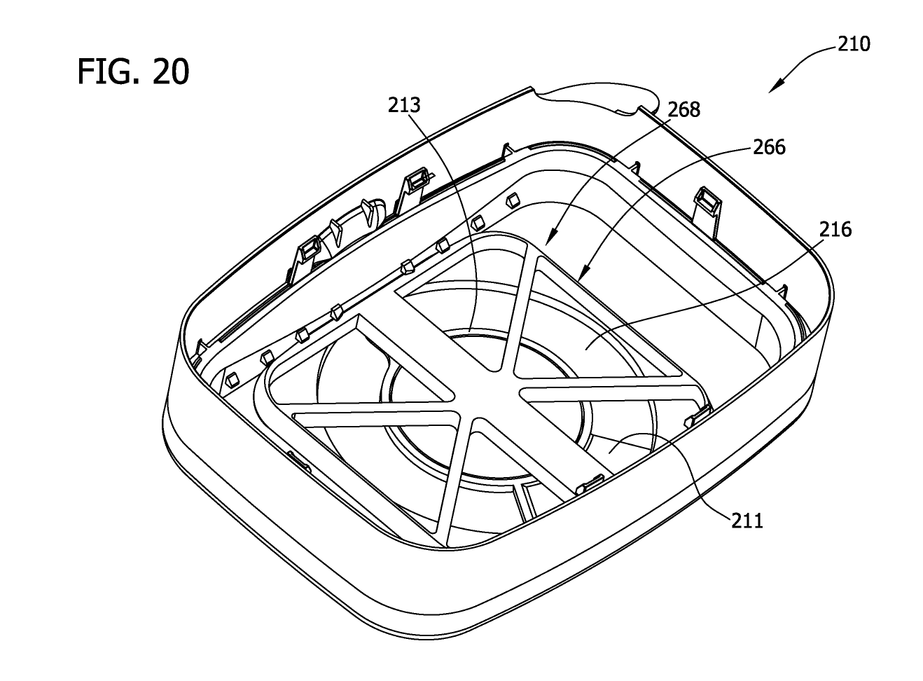

A second embodiment of a dispenser (FIGS. 18 and 19) and a third embodiment of a dispenser (FIGS. 20-23) are generally indicated at 110 and 210, respectively. Components of the second embodiment that are similar to disclosed components of the first embodiment are indicated by corresponding reference numerals plus 100, and like components of the third embodiment are indicated by corresponding reference numerals plus 200. These embodiments are similar to the first embodiment 10, except that a cavity cover 111 in the second embodiment 110 extends outward from the interior surface of the body 114 and is sized and shaped to cover the inlet of one of the metering cavities 148 of the metering disk 116 when the metering cavity is angularly aligned and in communication with the exit opening 192. The cavity cover 111 isolates the metering cavity 148 from the powdered beverage above the metering cavity when the metering cavity is angularly aligned with the exit opening 192 so that only the metered amount of powdered beverage in the metering cavity is dispensed.

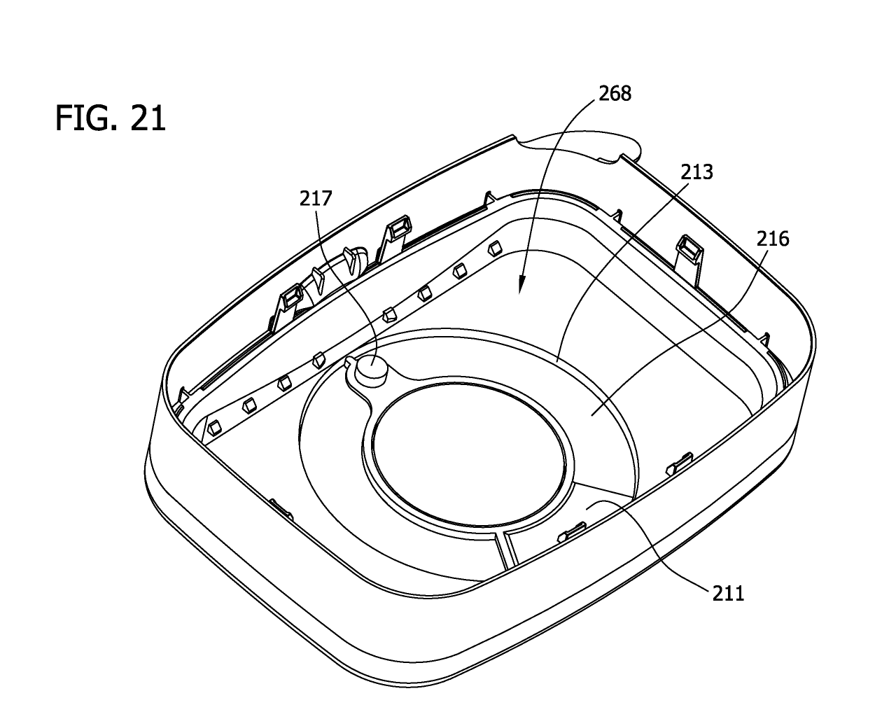

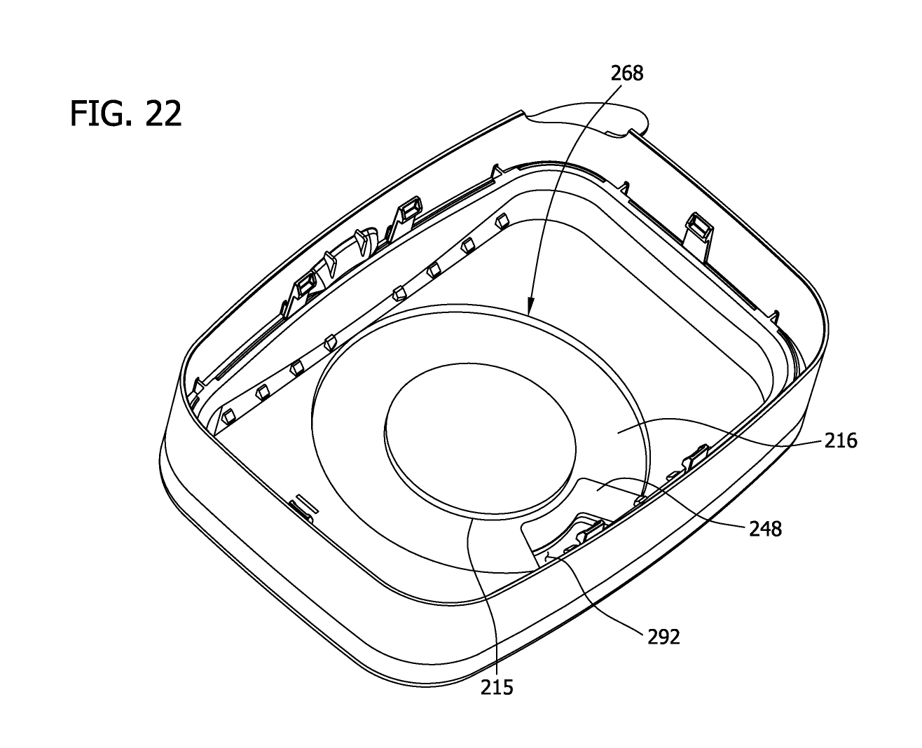

With respect to the third embodiment of the dispenser 210 (FIGS. 20-23), a cavity cover 211 extends radially outward from an attachment ring 213 and covers the exit opening 292. The ring 213 is rotatably received on a bearing surface 215 (FIG. 22) of the metering disk 216. The attachment ring 213 includes a coupling pin 217 generally diametrically opposite the cover 211. The coupling pin 217 is received in the slot 284 (FIG. 23) of the agitator 266 so that oscillating movement of the agitator imparts limited (i.e., less than 360 degrees) pivoting or swinging of the cavity cover 211 on the bearing surface 215. In use, the cover 211 covers the inlet of the metering cavity 248 when the cavity is angularly aligned with the dispensing outlet 292. As the metering disk 216 rotates from this angular position and imparts linear motion to the agitator 266, the cavity cover 211 follows the metering cavity 248 until the agitator reaches the longitudinal end of the guideway 268. When the agitator 266 reaches the longitudinal end of the guideway 268, the cavity cover 211 stops rotating and the metering disk 216 continues to rotate past the cavity cover to open the metering cavity 248. Toward the end of the first segment of revolution, the cover 211 pivots in an opposite direction over the dispensing outlet 292. As the metering disk 216 continues to rotate, the metering cavity 248 follows the cover 211 back toward the exit opening 292 and angularly aligns with the cover and the dispensing outlet. Other ways of covering the inlet of the metering cavity 248 when the cavity is angularly aligned with the exit opening 292 do not depart from the scope of the present invention.

Referring to FIGS. 24-32, a fourth embodiment of a dispenser is generally indicated at 310. In the illustrated embodiment, the dispenser 310 includes a body, generally indicated at 314, and a metering member, generally indicated at 316, disposed in the body. In general, the illustrated dispenser 310 may be adapted to be secured to the container 12 in a manner substantially similar to any of the ways disclosed above with respect to the first embodiment. For example, in the illustrated embodiment a securement collar 322 includes snap-fit fasteners 326 (e.g., snap-fit hooks as illustrated) that are attachable to mateable snap-fit fasteners 28 (e.g., snap-fit openings or undercuts as illustrated) of the container 12. The dispenser 310 may be secured to the container 12 or to another type of container in other ways, including any of the ways disclosed above. For example, the dispenser 310 may be securable to the container 12 in a similar fashion as that described above with respect to the embodiment illustrated in FIG. 13. In particular, the dispenser 310 may include a hinged fastener similar to the hinged fastener on the lid to hingedly fasten to the container 12 at a hinged connection. Moreover, the dispenser 310 may include fasteners (e.g., snap-fit fasteners) that removably secure the dispenser over the top of the container (e.g., the packaging collar) so that the dispenser also functions as the lid of the container.

Unlike the previous embodiments, the metering member 316 comprises a conical hub 334 and a plurality of low-profile metering fingers 336 extending radially outward from a base of the hub. In the illustrated embodiment, the metering member 316 includes ten metering fingers 336. It is understood, however, that the metering member may comprise more or less than ten metering fingers without departing from the scope of the present invention. The metering fingers 336 are spaced circumferentially and equidistantly around the base of the hub 334 to define a plurality of metering cavities 338 between adjacent fingers. In the illustrated embodiment, the metering fingers 336 and the hub 334 collectively and broadly define an annular disk (e.g., a metering disk) having a plurality of metering cavities 338 extending through opposite axial faces of the disk. While not illustrated herein, it is contemplated that the terminal outer ends of the metering fingers 336 may be connected by a ring or discrete webs. The metering fingers 336 suitably have uniform shapes and sizes and the metering cavities 338 have substantially uniform depths and capacities. For example, the depths of the cavities may be less than about 12 mm, suitably within a range between about 2 mm and about 12 mm, more suitably, between about 4 mm and about 6 mm. Preferably, the size and shape of the exit opening 362 generally corresponds to the size and shape of each of the metering cavities 338. Moreover, the size of each metering finger 336 is such that the metering finger covers the exit opening 362 and inhibits powdered beverage from entering the exit opening and foreign substances (e.g., moisture, pests, etc.) from entering the container when the metering finger is positioned over the opening.

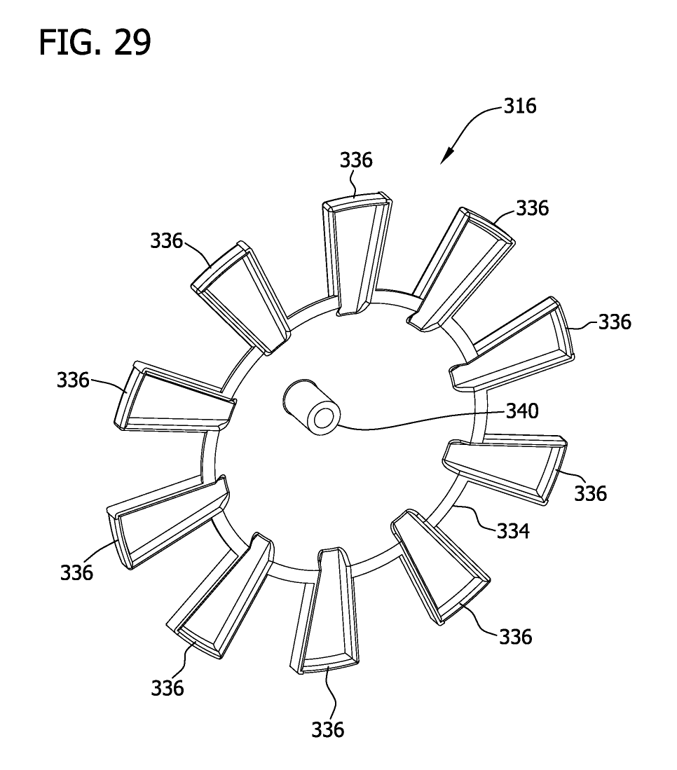

A drive coupling 340 (FIG. 29) on the hub 334 operatively connects the metering member 316 to the drive system 56 of the dispensing appliance 58, (FIG. 17) for rotating the metering member about a rotation axis A_{R}. Suitable embodiments and examples of the drive coupling 340 and the drive system 56 are described above with respect to the first embodiment. The conical hub 334 includes a plurality of agitators in the form of ribs 337 that are circumferentially spaced apart from one another about the exterior surface of the hub. Each rib 337 extends from adjacent the apex of the hub 334 toward the base. The conical hub 334 and the ribs 337 both facilitate movement of the powdered beverage toward the metering cavities 338 between the fingers 336 and facilitate declumping of the powdered beverage as the hub rotates. It is understood that the hub 334 may be of other configurations without departing from the scope of the present invention.

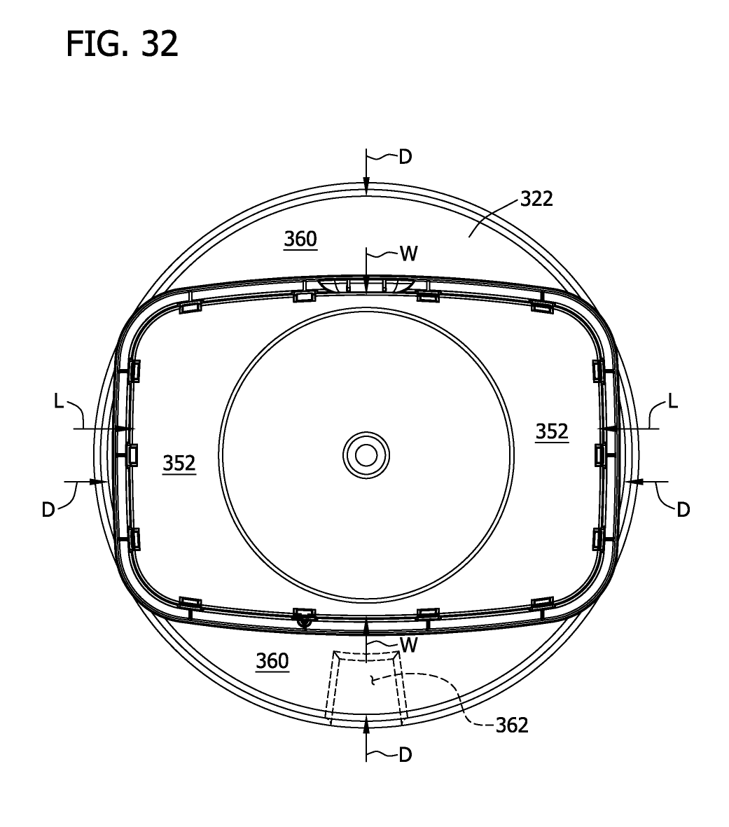

The dispenser body 314 of this embodiment includes a collar component 342 removably secured to an end cap 344. The end cap 344 includes a conical bearing projection 348 on which the conical hub 334 is rotatably received. The collar component 342 and the end cap 344 together define an annular bearing recess 350 in which the metering fingers 336 are slidably received. The annular bearing recess 350 is defined by an axial bearing surface 352 of the end cap 344, and a generally cylindrical bearing surface 354 of the collar component 342. The cylindrical bearing surface 354 is defined by an annular flange 356 that extends into the bearing recess 350. As seen in FIG. 32, the cylindrical bearing recess 350 has an outer diameter D that is greater than an interior width W of the securement collar 322 extending between the interior side surfaces of the collar. As such, portions of the recess 350 extend radially outward beyond interior side surfaces of the securement collar 322, and thus, the portions of the recess extend radially outward beyond interior side surfaces of the container 12. Preferably, the diameter D of the annular bearing recess 350 is slightly larger or about the same as the interior length L of the securement collar extending between interior longitudinal end surfaces of the collar. As such, the recess 350 does not extend substantially beyond the longitudinal end surfaces of the securement collar 322. The portions of the annular bearing recess 350 extending beyond the interior side surfaces of the collar 322 are covered by cover portions 360 extending laterally outward from the collar. A dispensing outlet 362 extends from a covered portion of the axial bearing surface 352 through the dispenser body 314. The diameter of the annular bearing recess could also be substantially smaller than the interior width of the container or substantially larger than the interior length of the container without departing from the scope of the present invention.

The dispenser body 314 and the metering member 316 are assembled together to form the dispenser body 10. In one example, the dispenser components are removably attached to one another so that the assembled dispenser 10 can be easily disassembled for cleaning purposes. The dispenser body 14 may be formed as a two-piece structure, with the securement collar 322 formed as one piece and the conical bearing projection 348 and a cap 368 defining the annular bearing recess 350 formed as a separate piece. The cap 368 may be removably secured to the securement collar 322 to trap the metering member 316 in the dispenser body 314. The two-piece dispenser body 314 and the metering member 316 may be formed from a suitable plastic or from other materials. For example, each of the components may be formed by any suitable molding technique. The dispenser body 314 and the metering member 316 may be formed of other material and may be formed in other ways without departing from the scope of the present invention.

In use, the packaging (not shown) including the container 12 with the dispenser 310 secured thereto, is positioned generally upside down to interface the dispenser 310 with the dispensing appliance 58, such as described above with respect to the first embodiment. With the packaging properly interfaced with the dispensing appliance 58, the dispensing appliance can automatically dispense powdered beverage from the container 12 by rotating the metering member 316. As can be understood, more than one metering cavity 338 is emptied during a single revolution of the metering member 316. Moreover, each cavity 338 is filled with a metered amount of powdered beverage from the container 12 by gravity when it is not covered by the cover portions 360. That is, when each cavity 338 is in an angular position such that it not covered by one of the cover portions 360, an inlet of the cavity is open and an outlet of the cavity is covered by the axial bearing surface 352. As the cavity 338 passes under the cover portions 360, the cavity is no longer in communication with the container 12. When the metering cavity 338 passes over the dispensing outlet 362, the metering inlet of the cavity is closed by one of the cover portions 360 and a metering outlet of the cavity opens to the dispensing outlet to dispense the metered amount of powdered beverage.

As with the first embodiment, it is envisioned that the dispensing appliance 58 may include a user interface in communication with a controller (e.g., a microcontroller, not shown) to allow a user to select a dose of the powdered beverage and an amount of liquid to be mixed or an amount (e.g., fluid ounces) of end product (i.e., powdered beverage mixed with liquid) that the user wants made. The operation of the dispensing appliance 58 with the dispenser 316 may be substantially similar to the operation of the dispensing appliance with the first embodiment of the dispenser 310. Moreover, the amount of metered powdered beverage dispensed by a single metering cavity 338 (i.e., a capacity of each metering cavity) may be a fraction of a minimum target dose of powdered beverage that can be selected for dispensing or the capacity may be substantially equal to the minimum target dose.

It is envisioned that any of the dispensers 10, 10′, 110, 210, 310 disclosed above, including variations of the dispensers, may be a component of a dispensing appliance. It is also envisioned that the dispensing appliance may include a container for receiving the powdered beverage. For example, the dispenser may be a removable or non-removable component of the dispensing appliance and may be removably or non-removably from the container. Moreover, the container may be a removable or non-removable component of the dispensing appliance. It is envisioned that in such an embodiment, the powdered beverage will be poured into the container from an original package when the container is in the dispensing appliance. Dispensing of the powdered beverage will be substantially similar to those embodiments described above.

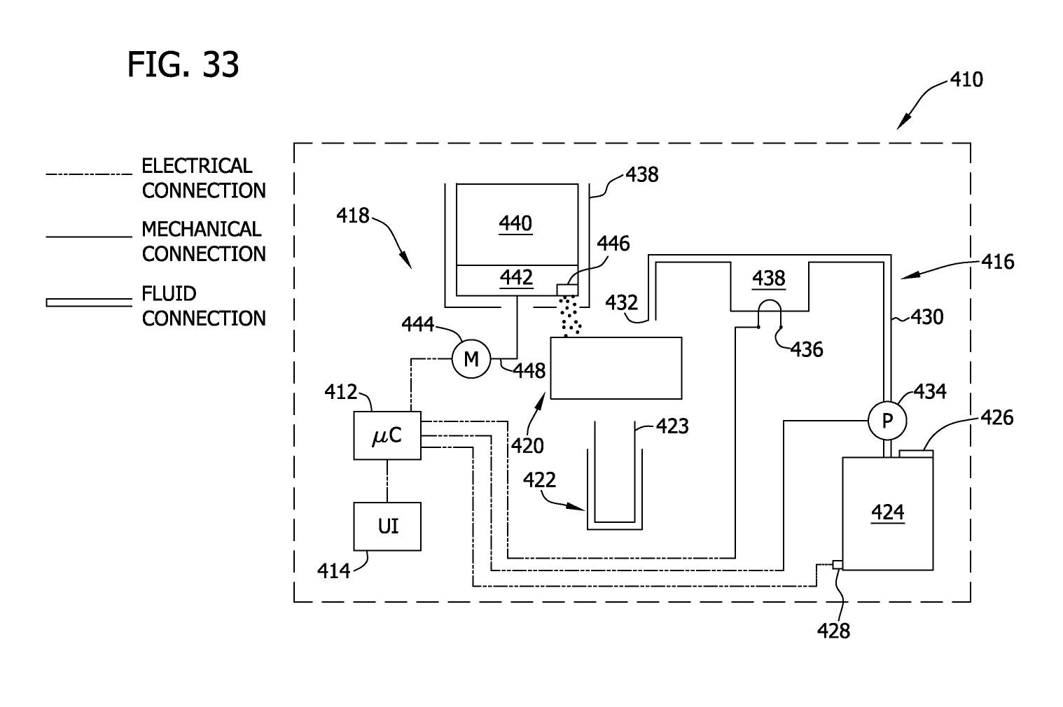

Referring to FIG. 33, one particularly suitable embodiment of a dispensing appliance is illustrated schematically at 410. The illustrated dispensing appliance 410 includes functional systems (as seen in FIGS. 3 and 4 and described previously) that are assembled together in a single unit, although it is understood herein that such systems may comprise separate units acting as a single dispensing appliance. In general, the dispensing appliance 410 comprises a liquid delivery system, generally indicated at 416, and a powder delivery system, generally indicated at 418, that respectively dispense a desired quantity of water (broadly, a liquid) and a desired amount of powdered infant formula (broadly, a powdered beverage) to a mixing station, generally indicated at 420. The water and infant formula are admixed at the mixing station 420, and the end product infant formula is delivered through an opening in a housing of the appliance to a receptacle receiving station, generally indicated at 422, which in the illustrated embodiment comprises a nursing bottle 423 but may otherwise comprise any suitable receptacle.

Referring still to FIG. 33, the liquid delivery system 416 of the illustrated embodiment comprises a liquid reservoir 424 for holding a quantity of water (or other liquid, such as milk) In one embodiment, the liquid reservoir 424 may be an integral, non-removable component of the appliance 410 that is accessible by a user so that the reservoir can be filled with liquid and refilled after it is depleted. For example, in the illustrated embodiment, a lid 426 over an opening of the reservoir 424 can be removed to fill the reservoir. It is also envisioned that the reservoir 424 may have a liquid level sensor 428 for detecting when the reservoir needs to be refilled. Other ways of making the liquid reservoir 424 accessible and other ways of filling the reservoir with liquid do not depart from the scope of the present invention. For example, in another embodiment the liquid reservoir 424 may be removable from the dispensing appliance 410 to fill the reservoir. The liquid reservoir 424 may also be cleaned after it is removed from the appliance 410. Moreover, the liquid delivery system 416 may not include a reservoir without departing from the scope of the present invention. For example, the liquid delivery system 416 may be fluidly connectable to an external supply of liquid, such as an external supply of water, including but not limited to a public water system. Moreover still, as explained above, the liquid reservoir may include a liquid level sensor for detecting the quantity of liquid in the reservoir to indicate the quantity of end product liquid mixture that the user wants made.

In the illustrated embodiment, a liquid conduit 430 (e.g., tubing, illustrated schematically in FIG. 33) fluidly connects the liquid reservoir 424 to a liquid outlet 432, which directs water from the reservoir into the mixing station 420. A suitable pump 434, such as an electric pump, is in fluid communication with the liquid conduit 430 and operable to deliver water from the reservoir 24 to the outlet 432. The pump 434 may be a centrifugal pump or another type of suitable pump. The pump 434 is electrically connected to a controller 412 that operates the pump to control the flow rate and quantity of liquid delivered to the mixing station 420. It is understood that the liquid delivery system 416 may not include a pump and remain within the scope of the present invention. For example, the liquid delivery system 416 may be configured to deliver water to the mixing station 420 by gravity. In one such example, the liquid reservoir 424 may be positioned above the liquid outlet 432 and the mixing station 420, and the liquid outlet may comprise a control valve (not shown) for opening and closing the outlet.

Referring still to FIG. 33, the liquid delivery system 416 may also include a heater 436 for heating the liquid before it is dispensed through the outlet 432. For example, the liquid delivery system 416 may include a heating chamber 438 downstream from the pump 434 that is in thermal contact with the heater 436. Liquid entering the heating chamber 438 may be heated to a desired temperature, such as from about 60° F. (16° C.) to about 140° F. (60° C.). A heating chamber control valve (not shown) may be positioned downstream of the heating chamber 438 to retain the liquid in the heating chamber for a desired period of time before allowing the liquid to flow to the liquid outlet 432. A liquid temperature sensor (not shown) may also be disposed downstream of the heating chamber 438 to ensure that the temperature of the liquid exiting the heating chamber is not above an upper threshold temperature. The controller 412 may be electrically connected to any or all of the heater 436, the heating chamber control valve, and the temperature sensor for controlling the heating of the liquid. Other ways of heating the liquid before it is dispensed through the liquid outlet 432 do not depart from the scope of the present invention. Moreover, it is understood that the dispensing appliance 410 may not include a heater and remain within the scope of the present invention. Furthermore, it is contemplated that the appliance 410 may include a cooler or chiller for cooling (i.e., removing heat) from the water or other liquid. It is also contemplated that the appliance 410 may include a filter for filtering the liquid prior to the liquid being dispensed.

The controller 412 (e.g., a microcontroller) is adapted to control various functions of the dispensing appliance 10, as explained in further detail later herein. The dispensing appliance 410 may also include a user interface 414 (see also interface 59a of FIGS. 16 and 17) to allow a user to select, for example, a desired amount of an end product beverage that he/she wants made and to communicate this selection to the controller 412. Alternatively, the amount of liquid added by the user to the liquid reservoir may dictate the desired amount of the end product beverage. The user interface 414 may allow for the user to make other selections, including, but not limited to, a temperature of the end product beverage, a composition of the end product liquid beverage mixture (e.g., adding optional ingredients), and a type of beverage when the dispensing appliance is configured to dispense multiple types of beverages. The user interface 414 may comprise any combination of a mechanical input device(s), a graphical user interface, and a touchscreen. The user interface 414 may alternatively, or additionally, comprise other types of user interface components. A control system of the dispenser comprises the controller 412 and the user interface 414, but the control system may include other control components or additional component without departing from the scope of the invention.

The powder delivery system 418 of the illustrated embodiment comprises a suitable container mount 438 for releasably mounting a container 440 of powdered infant formula (i.e., broadly, the powdered beverage) thereon. The container mount 438 may include fastening components, such as snap-fit fastener components (now shown), for releasably securing the container 440 on the mount. In the illustrated embodiment, the mount 438 is disposed in an enclosed compartment (see FIG. 16, for example) of the dispensing appliance 10 so that the container 40 is inserted into the compartment and positioned on the mount. In a particular example, the container 440 may be part of disposable packaging to act in the manner of a cartridge. When the container 440 is empty, the container may be removed and disposed of (e.g., thrown away or recycled), and a new container of powdered beverage can be loaded into the appliance 410. The mount 438 may have other configurations without departing from the scope of the present invention.

In one example, the container 440 may include a dispenser 442 operable to dispense powdered beverage substance from the container. The dispenser 442 is selectively operated by a drive system 444 of the powder delivery system 418. In one embodiment, the dispenser 442 is operatively connectable to the drive system 444 upon loading the container 440 in the appliance 410. Referring to FIG. 33, the illustrated drive system 444 comprises a motor, such as an electric motor having a drive shaft 448 operatively connected to the dispenser 442. The drive system 444 (e.g., the motor) is electrically connected to the controller 412 so that the controller can selectively dispense a desired amount of powdered infant formula from the container 440 by controlling operation of the dispenser. The dispenser 442 has an exit or outlet 446 through which the powdered beverage substance is dispensed. It is understood that the dispenser 442 may be of any suitable configuration without departing from the scope of the present invention. For example, the dispenser 442 may be of the same or similar configuration as any of the dispensers 10, 10′, 110, 210, 310 disclosed above herein.

In another suitable embodiment, the dispenser 442 may be a component of the powder delivery system 418. In such an example, the dispenser 442, which may be substantially similar in function and structure to the dispenser described above, may be a non-removable component of the powder delivery system 418 or may be removable from the appliance 410, such as for ease of cleaning Similarly, the container 440 may also be a refillable, and removable or non-removable component of the dispensing appliance 410.

The mixing station 420 may comprise any device that is suitable for receiving and mixing powdered beverage substance (e.g., powdered infant formula) and liquid (e.g., water) dispensed from the respective powder delivery system 418 and liquid delivery system 416. For example, the mixing station may comprise a mixing funnel, or a vibratory device, or another device that agitates and mixes the powdered beverage in the liquid. In one embodiment and as illustrated, after the powdered beverage substance and the liquid are mixed in the mixing station 420, the liquid beverage mixture is dispensed through the opening in the housing of the appliance and into the receptacle 423. In another embodiment, the receptacle receiving station 422 may include the mixing station 420, whereby the powdered beverage and the liquid are delivered to a receptacle (e.g., 423) and are mixed in the receptacle. It is understood that the dispensing appliance 410 may not include a mixing station 420. For example, the dispensing appliance 410 may be configured to dispense the powdered beverage and liquid into a receptacle, and then the user manually mixes the powdered beverage and the liquid.

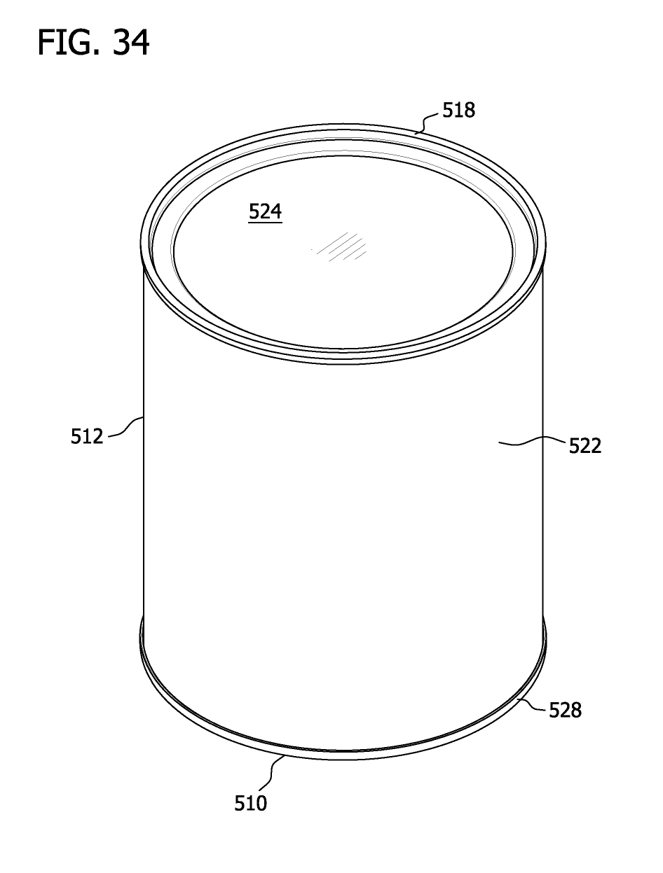

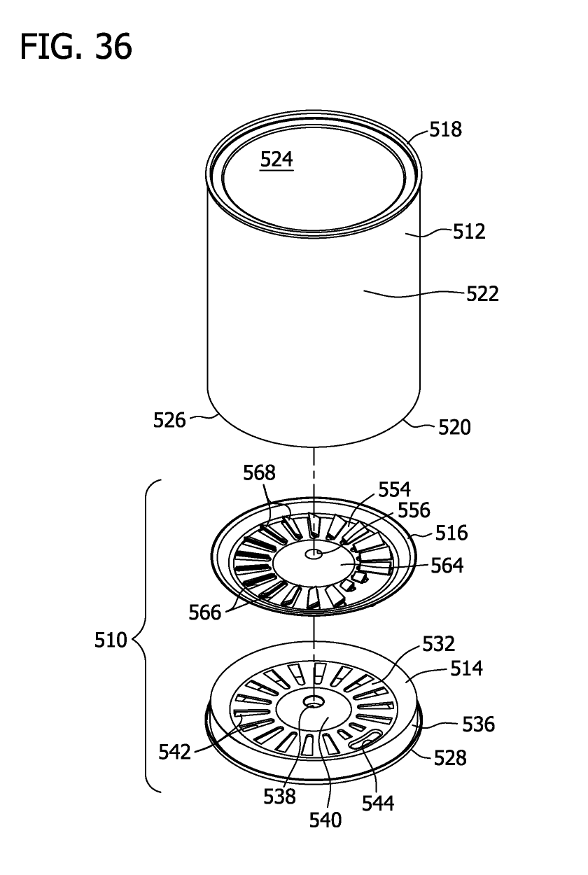

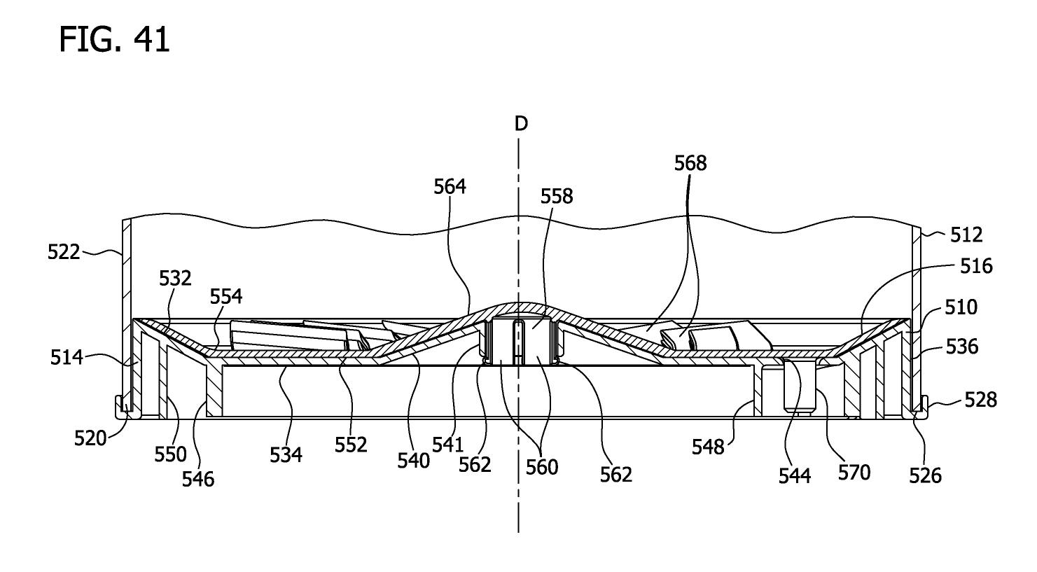

With reference now to FIGS. 34-41, in another embodiment of packaging for a powdered beverage the packaging is illustrated as a generally cylindrical container 512 having opposite ends 518, 520 and a cylindrical sidewall 522 extending therebetween. The bottom end 518 of the container 512 is suitably permanently closed by a bottom panel 524, as seen best in FIG. 34 in which the container is shown in a generally inverted orientation. The illustrated sidewall 522 defines a terminal rim 526 (best seen in FIGS. 36 and 41) of the container 512 at the top end 520 thereof. In this embodiment, a dispenser, generally indicated at 510, is connected to the container 512 generally at the top end 520 of the container for dispensing powdered beverage (not shown) from the container. In one particularly suitable configuration, the dispenser 510 is non-removably connected to the container 512 such as by adhesive bonding, heat welding or other suitable non-removable connection. In other embodiments the dispenser 510 may be releasably connected to the container 512, such as by a snap-fit connection, friction fit or other releasable connection.

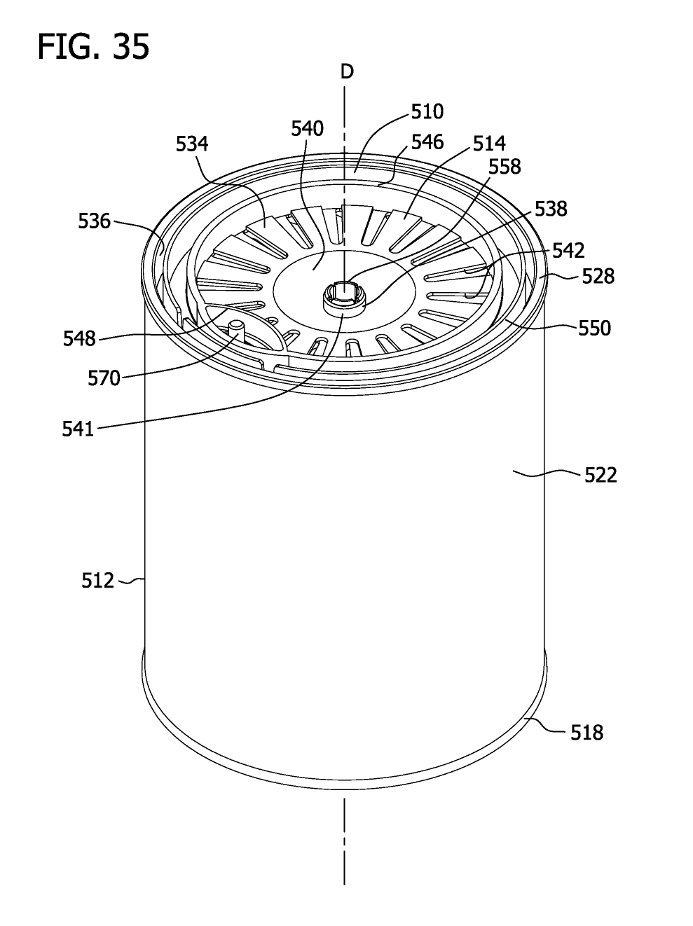

As illustrated in FIGS. 35 and 41, the dispenser 510 of this embodiment includes an annular mounting flange 528 that seats over the rim 526 of the container 512 to locate and mount the dispenser on the container. In this manner, the dispenser 510 sits substantially longitudinally inward of the rim 526 of the container 512 (e.g., substantially within the container). Accordingly, while not illustrated in the drawings of this embodiment, a suitable closure such as a foil seal and/or a lid may be disposed on the packaging overlying the dispenser 510 such that the dispenser may be packaged already assembled with the packaging container 512 to provide a hermetically sealed package with the dispenser included with the packaging. For such an embodiment, in one exemplary process for packaging the powdered beverage a closure such as a foil seal is secured to the dispenser 510 and the dispenser and seal are together secured to one end of the container, with the opposite end of the container still being open (i.e., with no bottom panel). Alternatively, the dispenser may be secured to the container and the seal then secured to the dispenser and/or the container (i.e., overlying the dispenser). The assembly to this point is inverted (with the dispenser facing downward) so that the now open bottom of the container faces upward. The container is filled with powder, and then nitrogen is introduced into the interior space of the container to fill the head space. The bottom panel is then secured to the container to hermetically seal the powder and nitrogen in the container.

With reference to FIG. 36, the dispenser 510 is suitably of at least two-piece construction including an inner dispensing member 516 in interfacing relationship with the beverage powder in the interior space of the container 512, and an outer dispensing member 514 in opposed relationship with the inner dispensing member. As used in reference to the inner and outer dispensing members 516, 514, the terms inner and outer are used to mean that the inner dispensing member is longitudinally nearer the interior space of the container 512 than the outer dispensing member. In this manner, the dispenser 510 as fully assembled and connected to the container 512 generally defines a closure for the top end 520 of the container, with the inner dispensing member 516 in part defining the interior space in which the powdered beverage is contained.

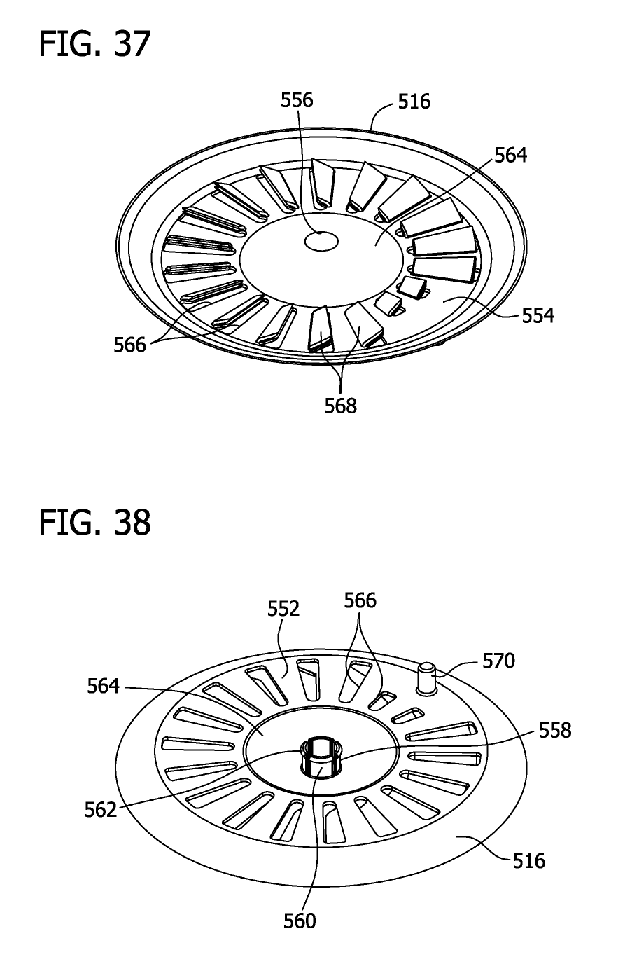

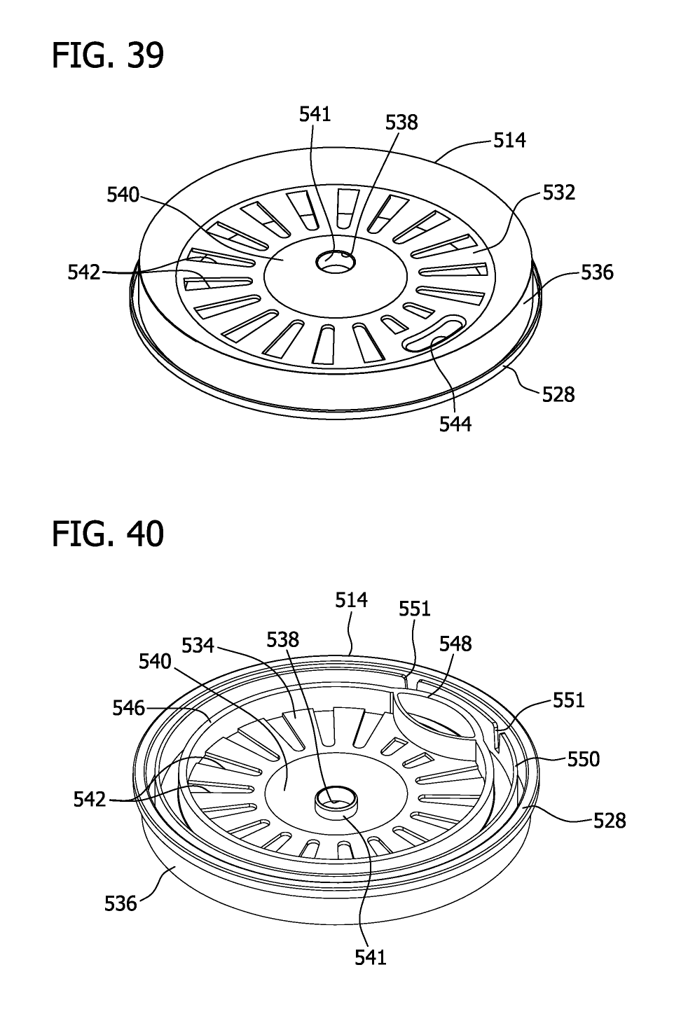

The outer dispensing member 514, with particular reference to FIGS. 39 and 40, is generally disc-shaped and has an inner surface 532, an outer surface 534, and an annular sidewall 536 having a free end configured as the annular mounting flange 528 of the dispenser 510 for receiving and seating over the rim 526 of the container 512 at the top end 520 thereof. When seated on the rim 526 of the container 512, the sidewall 536 of the outer dispensing member 514 extends longitudinally inward of the rim of the container such that the outer dispensing member—other than the portion thereof that defines the annular mounting flange 528 of the dispenser—is disposed substantially within the container. Additionally, the sidewall 536 of the outer dispensing member 514 abuts against, such as in contact or friction-fit engagement with, the sidewall 522 of the container 512 to position the dispensing member 510 on the container 512. In a more suitable embodiment, the sidewall 536 of the outer dispensing member 514 is adhesively bonded to the sidewall 522 of the container 512 to non-removably connect the dispenser 510 to the container. Accordingly, in this particular embodiment, the outer dispensing member 514 remains stationary during operation of the dispenser 510.

The outer dispensing member 514 has a central opening 538 disposed therein and a longitudinally extending annular hub 541 surrounding the opening. In the illustrated embodiment, a central region 540 of the outer dispensing member 514 surrounding the opening 538 is generally conical. It is understood, however, that the central region 540 of the outer dispensing member 514 may be other than conical, including planar, without departing from the scope of this invention. A plurality of exit openings 542, through which powdered beverage exits the container 512 upon dispensing, are disposed in angularly spaced relationship with each other about the outer dispensing member 514 radially intermediate the conical central region 540 and the sidewall 536 of the outer dispensing member.

In the illustrated embodiment, the outer dispensing member 514 includes eighteen exit openings 542 equally spaced from each other. For example, the illustrated exit openings 542 are equally spaced at twenty degree intervals, from the radial axis center of each opening. It is understood, however, that the outer dispensing member 514 may have more than eighteen exit openings 542, or it may have less than eighteen exit openings—including a single exit opening—and remain within the scope of this invention. As illustrated in FIGS. 39 and 40, sixteen of the exit openings 542 are of equal shape and size, while the two other exit openings are sized smaller for reasons that will become apparent. The size (e.g., the length and/or width, or total cross-sectional area) of the exit openings 542 (with the exception of the smaller exit openings) may in part be a function of the particular powdered beverage being dispensed, so as to allow powder to flow through while inhibiting the flow-through of big clumps. In one suitable embodiment, the total cross-sectional area of the opening(s) 542 (i.e., the sum of the cross-sectional areas of the exit openings) is in the range of about 1% to about 50% of the cross-sectional area of the container 512, and more suitably in the range of about 10% to about 40% of the cross-sectional area of the container.

An elongate, circumferentially extending slot 544 is also disposed in the outer dispensing member 514 radially intermediate the smaller exit openings 518 and the sidewall 536 of the outer dispensing member. As seen in FIG. 41, the outer dispensing member 514 is sloped longitudinally inward as it extends radially between the exit openings 542 and the sidewall 536 of the outer dispensing member. This sloped portion of the outer dispensing member 514 directs powder radially toward the exit openings 542, and along with the corresponding sloped portion of the inner dispensing member 516 also reduces any possible void space between the inner and outer dispensing members and inhibits loose play of the dispensing members during operation of the dispenser.

As best seen in FIG. 40, an annular deflector 546 projects longitudinally outward from the outer surface 534 of the outer dispensing member 514 generally radially adjacent but outward of the exit openings 542. The deflector 546 inhibits the radially outward flow of powdered beverage as it is dispensed from the exit openings 542 of the outer dispensing member 542, and instead guides the powdered beverage to flow downward away from the dispenser 510. A generally ovate enclosure 548 is formed, in part by the deflector 546, around the elongate slot 544 radially outward of the two smaller exit openings 543 to generally shield a drive system (as discussed in detail later herein) from powder dispensed from the dispenser 510.

An additional annular wall 550 projects longitudinally outward from the outer surface 534 of the outer dispensing member 514 radially intermediate the deflector 546 and the sidewall 536 of the outer dispensing member. This additional annular wall 550 includes a pair of circumferentially spaced alignment notches 551 (broadly, alignment members) to facilitate angular alignment of the packaging in a dispensing appliance as described later herein. While in the illustrated embodiment the alignment notches 551 are disposed circumferentially near the enclosure 548, it is understood that the alignment notches may be circumferentially located elsewhere about the annular wall 550. It is also contemplated that a single alignment notch 551, or more than two alignment notches, may be provided without departing from the scope of this invention.

Referring now particularly to FIGS. 37, 38 and 41, the inner dispensing member 516 is also generally disc-shaped and has an outer surface 552 (FIG. 38) for opposed relationship with the inner surface 532 of the outer dispensing member 514, and an inner surface 554 (FIG. 37) in part defining the interior space of the container 512 and interfacing with the powdered beverage therein. The inner dispensing member 516 has a generally cylindrical axle member 558 projecting longitudinally outward from the outer surface 552 at the center of the inner dispensing member. The axle member 558 has longitudinal slots formed therein and extending to the free end of the axle member to form discrete fingers 560 that are suitably resiliently deflectable for use in assembling the dispenser 510. In particular, as best illustrated in FIG. 41, the axle member 558 includes a radially outward extending flange 562 at the free end of the axle member (i.e., a discrete flange is formed at the free end of each of the discrete fingers 560 of the axle member).

The axle member 558 is suitably configured for insertion, free end first, through the central opening 538 and hub 541 of the outer dispensing member 514. The discrete fingers 560 deflect radially inward to accommodate the flange 562 of the axle member 558. Upon full insertion of the axle member 558 through the hub 541 of the outer dispensing member 514, the flange 562 of the axle member is positioned longitudinally outward beyond the hub. The bias of the inwardly deflected fingers 560 urges the fingers radially outward toward their undeflected configuration, with the flange 562 of the axle member now extending radially outward over the end of the hub 541 to releasably connect the inner and outer dispensing members 516, 514. As assembled, the inner dispensing member 516 is thus rotatable relative to the outer dispensing member 514 on a longitudinal rotation axis D defined by the axle member 558. It is understood that in other embodiments, the inner dispensing member 516 may be stationary while the outer dispensing member 514 is rotatable relative thereto, or both the inner and outer dispensing members may be rotatable relative to the container 512 as well as each other.

In the illustrated embodiment, a central region 564 of the inner dispensing member 516 is generally conical, and more suitably is shaped in accordance with the central region 540 of the outer dispensing member 514 as illustrated in FIG. 41. A plurality of dispensing openings 566 are disposed in angularly spaced relationship with each outer about the inner dispensing member 516 radially outward of the central region 564 of the inner dispensing member. In the illustrated embodiment, the inner dispensing member 516 includes eighteen dispensing openings 566 equally spaced from each other and more suitably sized, shaped and spaced from each other in one-to-one correspondence with the exit openings 542 in the outer dispensing member 514, including having two smaller dispensing openings to correspond with the two smaller exit openings in the outer dispensing member. It is understood, however, that the dispensing openings 566 in the inner dispensing member 516 may be shaped and/or sized different from the exit openings 542 in the outer dispensing member 514 without departing from the scope of this invention. It is also understood that the inner dispensing member 516 may have more than eighteen dispensing openings 566, or less than eighteen dispensing openings—including a single dispensing opening—and remain within the scope of this invention. Further, while in the illustrated embodiment there is an equal number of dispensing openings 566 and exit openings 542 in the respective inner and outer dispensing members 516, 514, it is contemplated that the number of dispensing openings in the inner dispensing member may be more or less than the number of exit openings in the outer dispensing member.

As illustrated in FIG. 37, the inner dispensing member 516 further comprises at least one and more suitably a plurality of agitators 568 projecting longitudinally inward (at least in part) from the inner surface 554 of the inner dispensing member. In the illustrated embodiment, the inner dispensing member 516 includes one agitator 568 corresponding to each dispensing opening 566. However, the number of agitators 568 need not correspond to the number of dispensing openings 566 to remain within the scope of this invention. The illustrated agitators 568 more suitably project from the inner surface 554 of the inner dispensing member 516 in part longitudinally and in part generally circumferentially to define a projection angle of the agitators relative to the inner surface of the inner dispensing member. For example, in one embodiment the projection angle of the agitators 568 is suitably in the range of about 10 degrees to about 90 degrees, and more suitably in the range of about 10 degrees to about 60 degrees. In the illustrated embodiment the projection angle of the agitators 568 is approximately 30 degrees. The projection angle of the agitators 568, however, may be less than or greater than the above range. It is also contemplated that the projection angle of one or more agitators 568 may be different from the projection angle of one or more other agitators. It is also understood that the relative height (i.e., longitudinally inward extension away from the inner surface 554 of the inner dispensing member 516) of the agitators 568 may be other than as illustrated and remain within the scope of this invention.

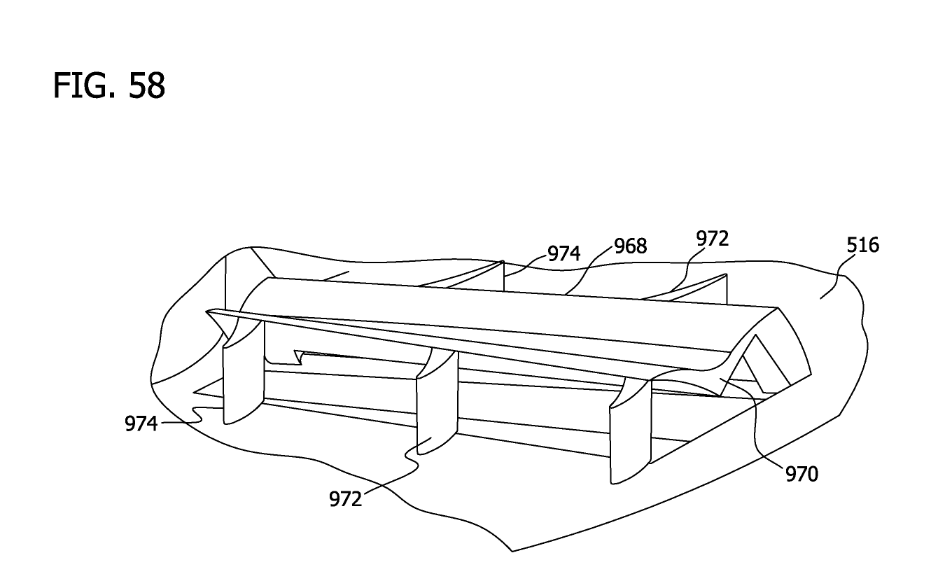

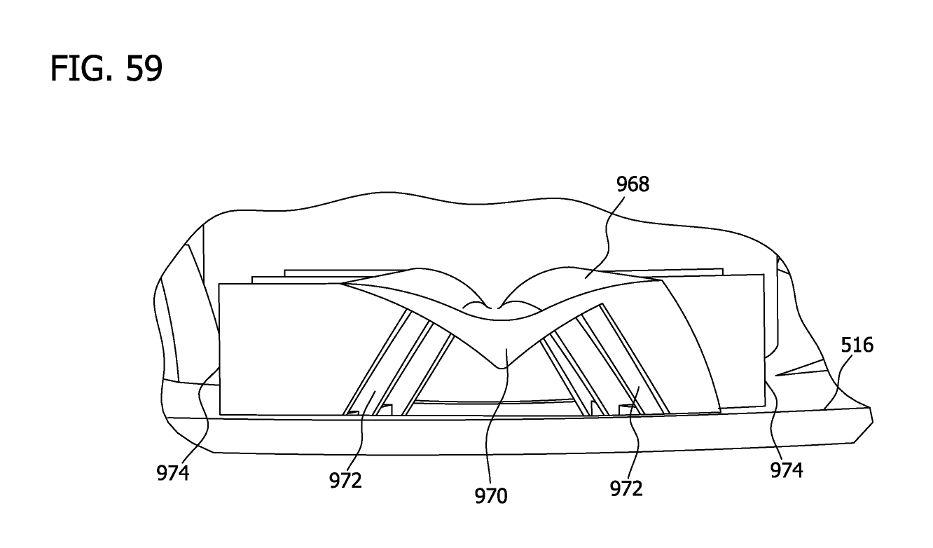

FIGS. 58 and 59 illustrate an alternative embodiment of suitable agitators 968 (broadly, one more powder flow promoting members) for the inner dispensing member 516. In this embodiment, the agitator is more in the form of a canopy 970 supported by suitable projecting tabs 972 in spaced relationship with the respective dispensing opening 966. The projecting tabs 972 project generally circumferentially from the canopy 970, away from the dispensing opening 966. These tabs 972 taper to a terminal point 974 so that the tabs generally knife or cut through the powder in the container upon rotation of the inner dispensing member 516 to agitate the powder and to break up any packed or clumped powder. The projecting tabs 972 are radially spaced from each other to permit powder to pass therebetween to the dispensing opening 966. The canopy 970, as best illustrated in FIG. 59, is generally V-shaped to define opposed projection angles of the agitator 968. In this manner, the canopy 970 is also configured to knife or cut through the powder in the container upon rotation of the inner dispensing member 516 in either direction (clockwise or counter-clockwise), such as in particular embodiments where the inner dispensing member is oscillated in rotation.

It is understood, however, that only one circumferential side of the agitator 968 need be configured in the illustrated configuration, such as where the inner dispensing member 516 rotates only in a single direction, without departing from the scope of this invention. While in each of the embodiments disclosed herein the one or more agitators (powder flow promoting members) are moveble conjointly with the dispensing member, it is understood that the powder flow promoting members may be moveable within the container independent of operation of the dispensing member, and may be mechanically or manually driven, without departing from the scope of this invention. It is also contemplated that the one or more powder flow promoting members may remain stationary within the container and remain within the scope of this invention.

Referring again to FIGS. 38 and 41, the inner dispensing member 516 also has a drive pin 570 projecting longitudinally outward from the outer surface 552 thereof radially outward of the two smaller dispensing openings 566. The drive pin 570 is sized for disposition in the elongate circumferentially extending slot 544 of the outer dispensing member 514. For example, as illustrated in FIG. 35, the drive pin 570 extends through the slot 544 of the outer dispensing member 514 for disposition within the enclosure 548 projecting from the outer dispensing member 514. The inner dispensing member 516 is sloped longitudinally inward as it extends radially outward between the dispensing openings 566 and the side edge of the inner dispensing member in correspondence with the sloped portion of the outer dispensing member 514. The inner and outer dispensing members 516, 514, in accordance with one suitable embodiment, are constructed of plastic. In other suitable embodiments the inner and outer dispensing members 516, 514 may be constructed other than from plastic, such as a metal.

In the fully assembled configuration of the dispenser 510, the inner dispensing member 516 is capable of driven rotation, via the drive pin 570, relative to the outer dispensing member 514 between a blocked position of the dispenser in which powdered beverage is blocked against exiting the dispenser, and a dispensing position in which powdered beverage is dispensed from the dispenser. More particularly, in the blocked position of the dispenser the dispensing openings 566 of the inner dispensing member 516 are out of registry with the exit openings 542 of the outer dispensing member 514 such that powdered beverage cannot flow out of the exit openings. In the dispensing position, the inner dispensing member 516 is angularly positioned such that the dispensing openings 566 of the inner dispensing member are at least in part in registry and more suitably in full registry with the respective exit openings 542 of the outer dispensing member 514 to permit powdered beverage to exit the dispenser 510 at the exit openings. In a particularly suitable embodiment, the inner and outer dispensing members 516, 514 are configured and assembled together for oscillating rotary movement of the inner dispensing member relative to the outer dispensing member to facilitate repeated positioning of the dispenser between its blocked position and its dispensing position. It is understood, however, that in other suitable embodiments the inner and outer dispensing members 516, 514 may be configured and assembled together for continuous driven rotation in a single direction (e.g., full 360 degree rotation) without departing from the scope of this invention.

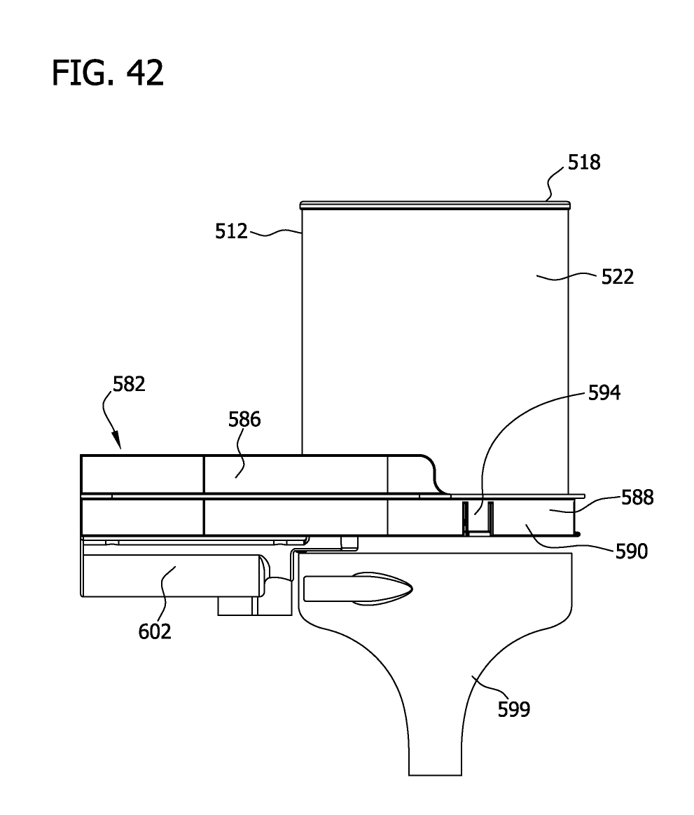

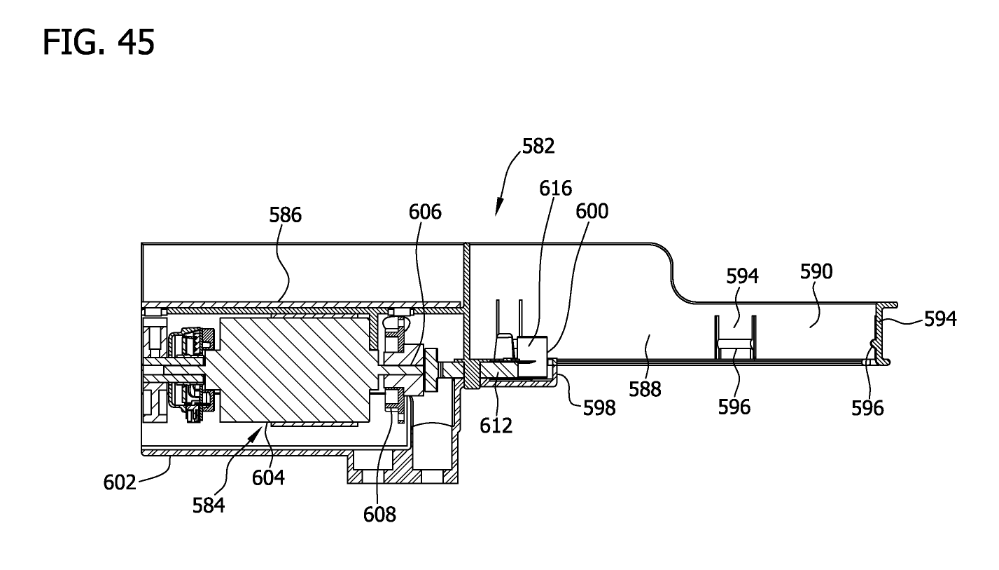

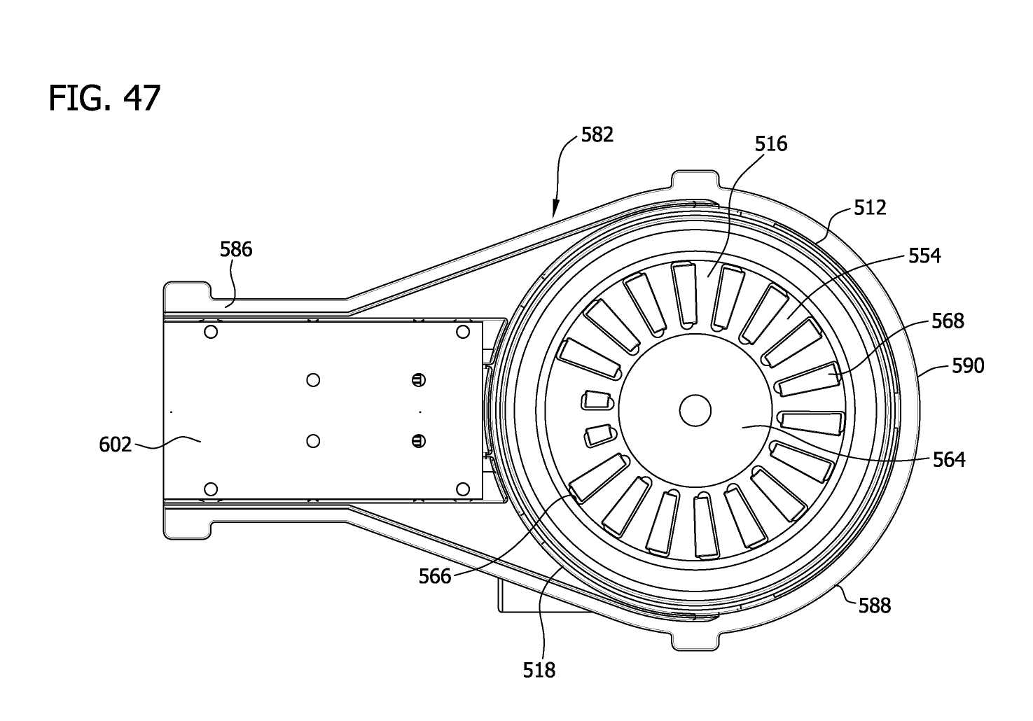

With reference now to FIGS. 42-47, the packaging and in particular the container 512 and dispenser 510 of the embodiment of FIGS. 34-41 may be used as a cartridge in a dispensing appliance, such as an appliance similar to the appliance 58 of FIG. 17 including a mixing funnel 599 that receives powdered beverage dispensed by the dispenser for admixture with a liquid in the funnel. It is understood, however, that the appliance 58 may be configured to only dispense powdered beverage, with or without the funnel 599 in place, for dispensing into a receptacle such as a cup, pitcher, blender or infant formula bottle. In general, the dispensing appliance is suitably configured to operate the dispenser 510 to automatically dispense a predetermined quantity of powdered beverage from the packaging. FIGS. 42-47 illustrate one suitable embodiment of an appliance mount, generally indicated at 782, and a drive system, generally indicated at 784, for supporting the packaging of FIGS. 34-41 and for driving operation of the dispenser 510 to dispense powdered beverage from such packaging.

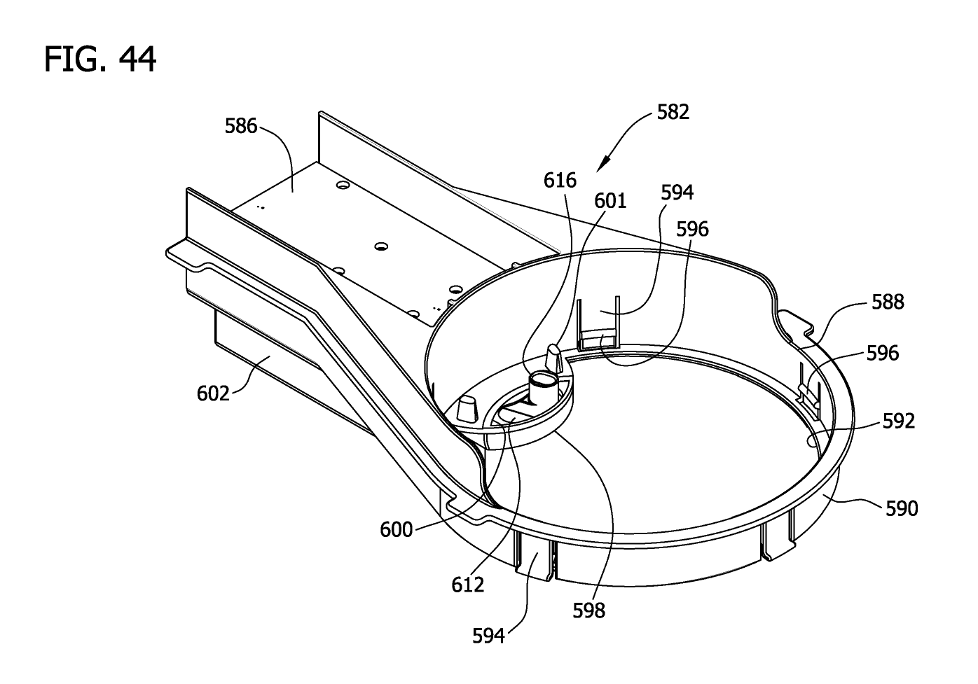

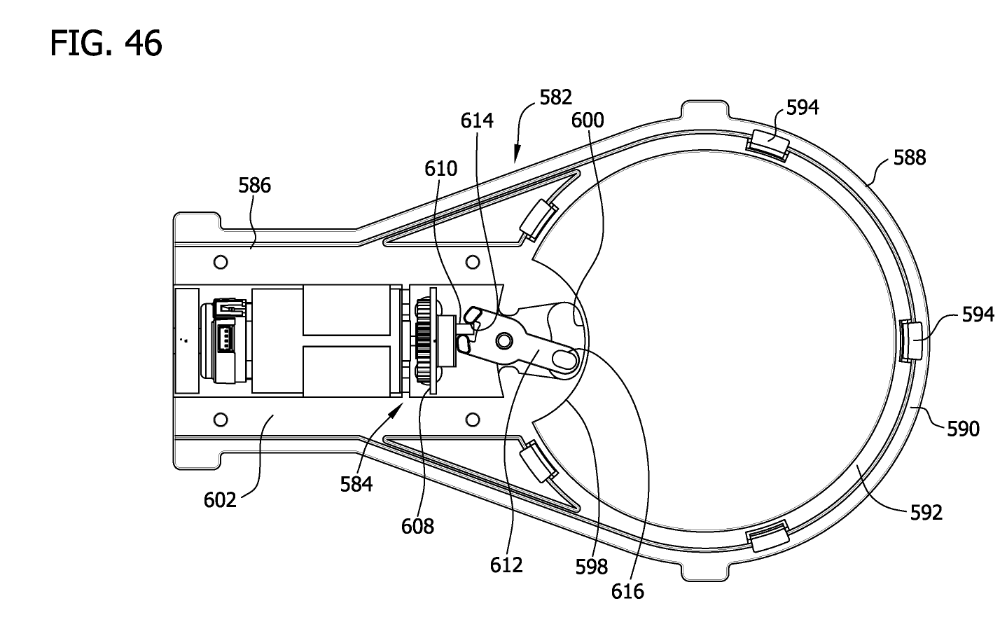

The mount 582 comprises a suitable mounting arm 586 configured for support by and more suitably connection to other support structure (not shown) of the dispensing appliance. An annular seat 588 extends transversely from the mounting arm 586 and includes a sidewall 590 and a generally ring-shaped base 592 extending radially inward from the lower end of the sidewall. A plurality of resilient retention members 594 (five are illustrated in FIGS. 44 and 46) are disposed on the sidewall 590 and extend from a connected end where the retention members are formed integral with the sidewall down to a free end that is generally longitudinally adjacent the ring-shaped base 592 of the mount 582. The retention members 594 are resiliently moveable relative to the sidewall 590 and include respective catches 596 extending radially inward from the retention members at a location longitudinally spaced from the free ends of the retention members.

An enlarged portion 598 of the base 592 of the mount 582 has a generally ovate opening 600 therein (the purpose of which is discussed in detail later herein), and more suitably an ovate opening that is shaped and sized to correspond to the generally ovate drive pin enclosure 548 of the outer dispensing member 514. Circumferentially spaced alignment tabs 601 project up from the enlarged portion 598 of the base 592 in correspondence with the alignment notches 551 of the annular wall 550 of the outer dispensing member 514.

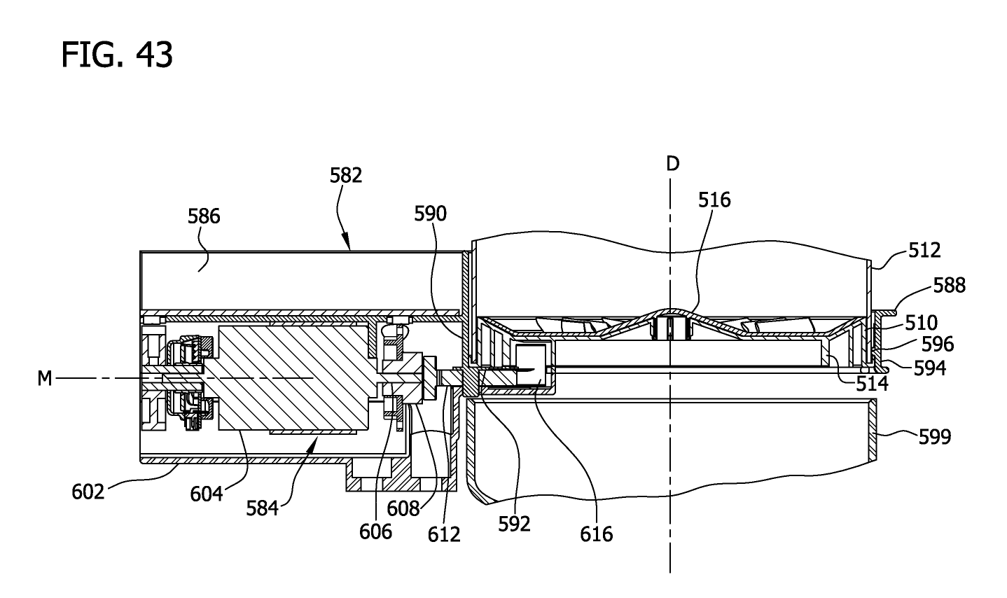

In the illustrated embodiment, a suitable drive system housing 602 is connected to the underside of and depends from the mounting arm 586 of the packaging mount 582. With reference to FIGS. 43, 44 and 46, the drive system 584 of the illustrated embodiment comprises a suitable motor 604 having a drive shaft 606 and an eccentric drive plate 608 operatively mounted on the drive shaft and including an eccentric pin 610 extending outward therefrom such that the motor operates to drive orbital rotation of the eccentric pin about a rotation axis M of the drive shaft. A suitable lever 612 is configured at one end with an elongate, vertically extending slot 614 for receiving the eccentric pin 610 therein and allowing the pin to travel up and down within the slot upon orbital rotation of the eccentric pin. The lever 612 is pivotally secured to the mount 582 to define a suitable pivot axis L of the lever transversely spaced from the end of the lever that is coupled to the motor 604 via the eccentric pin 610. Accordingly, the lever 612 oscillates in pivoting movement about its pivot axis L in response to operation of the motor 604.

The lever 612 extends further from the pivot axis L transversely outward of the mounting arm 586 to an opposite end disposed generally at the ovate opening 600 in the enlarged portion 598 of the base 592 of the mount 582. A pin 616 extends upward from the end of the lever 612 and is generally hollow for receiving therein the drive pin 570 of the inner dispensing member 516 to thereby operatively couple the inner dispensing member to the lever. In such an embodiment, the lever 612, its pin 616, and the drive pin 670 together broadly define a drive coupling for operatively connecting the dispenser 510 to the motor 604. Accordingly, oscillatory pivoting of the lever 612—upon operation of the motor 604—rotatably oscillates the inner dispensing member 516 relative to the outer dispensing member 514. In the illustrated embodiment, the motor 604 and corresponding drive shaft 606 are oriented generally horizontally such that the rotation axis M of the drive shaft is horizontal, and hence perpendicular to the rotation axis D of the dispenser and more suitably perpendicular to and intersecting the rotation axis of the dispenser. It is understood, however, that the rotation axis M of the drive shaft 606 may be other than perpendicular to the rotation axis D of the dispenser without departing from the scope of this invention.

To releasably mount the packaging (i.e., the cartridge) on the dispensing appliance mount 582, the packaging is generally inverted, e.g., to the orientation illustrated in FIG. 34, and inserted downward into the annular seat 588 of the mount. The annular wall 550 of the outer dispensing member 514 contacts the alignment tabs 601 on the enlarged portion 600 of the base 592 of the mount 582. The packaging may be rotated to angularly reposition the packaging until the alignment tabs 601 are received into the notches 551 in the annular wall 550 of the outer dispensing member, thus assuring proper angular positioning of the packaging on the mount 582.

As the packaging is lowered into the correct angular position, the flange 528 of the outer dispensing member 514 (that seats over the rim 526 of the container 512) contacts the radially inward extending catches 596 of the retention members 594 of the mount 582. The retention members 594 deflect resiliently outward to allow the flange 528 of the outer dispensing member 514 to move downward past the catches 596. The packaging is inserted further downward until the flange 528 of the outer dispensing member 514 rests on the ring-shaped base 592 of the annular seat 590. The retention members 594 are resiliently biased back toward their undeflected configuration as illustrated in FIG. 43 such that the catches 596 radially overlay the flange 528 of the outer dispensing member 514 to thereby releasably retain the packaging on the mount 582. Upon insertion of the packaging into the annular seat 590 of the mount 582, the drive pin 570 of the inner dispensing member 514 is received in the pin 616 of the drive system lever 612. In one particularly suitable embodiment, the drive system lever 612 is always returned to a home, or parked position such that the pin 616 is always in the same location when new packaging is inserted into the mount 582. This facilitates proper alignment of the drive pin 570 of the inner dispensing member 514 with the lever pin 616 of the drive system.

In operation to dispense powdered beverage from the packaging, the motor 604 is operated (e.g., such as by a suitable on/off button and more suitably by a control system programmed for operating the dispenser 510 to dispense a predetermined quantity of powdered beverage) to drive rotation of the eccentric pin 610, and hence to pivotally oscillate the lever 612. Operative coupling of the inner dispensing member 516 with the motor 604 via coupling of the drive pin 570 of the inner dispensing member with the drive system lever 612 translates the pivoting movement of the lever into oscillating rotary movement of the inner dispensing member relative to the outer dispensing member 514. Rotary movement of the inner dispensing member 516 in this manner repeatedly positions the dispenser 510 between its blocked position and its dispensing position to intermittently dispense powdered beverage from the packaging container (i.e., via the exit openings 542 in the dispenser) until a predetermined quantity of powdered beverage is dispensed. The agitators 568 repeatedly move back and forth (circumferentially) with the inner dispensing member 516, in contact with powdered beverage within the container 512, to thereby facilitate movement of the powdered beverage therein. It is understood, however, that the agitators 568 may be omitted without departing from the scope of this invention. It is also contemplated that a separate agitating system (i.e., not directly dependent on rotation of the inner dispensing member 514) may be used to agitate the powdered beverage within the container 512.

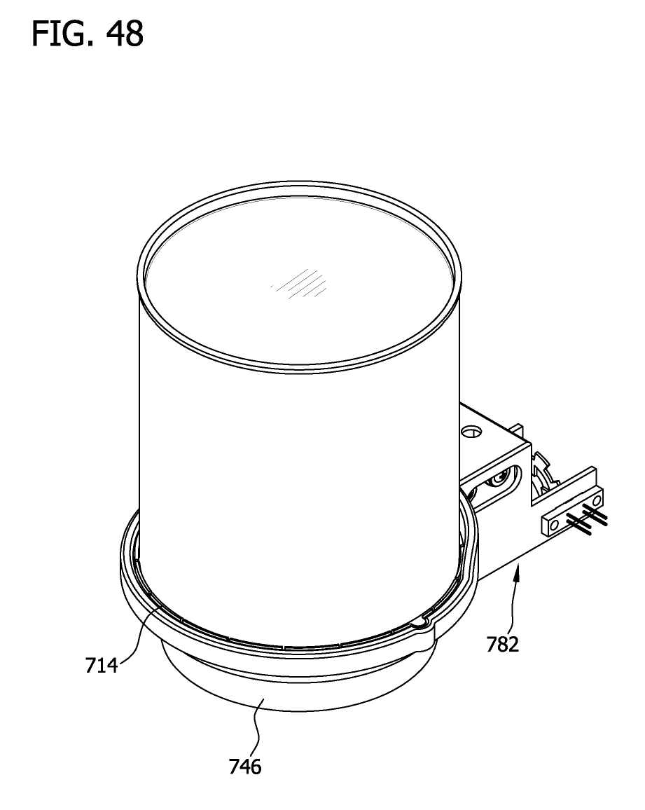

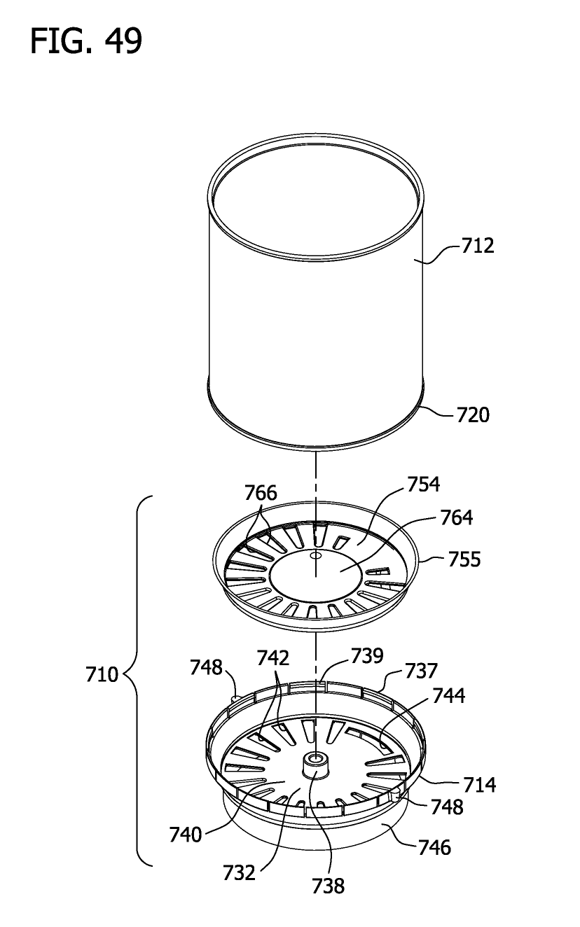

FIGS. 48-53 illustrate another embodiment of packaging including a container 712 and a dispenser 710 that is connected to the container generally at the top end 720 of the container. As illustrated in FIG. 49, the dispenser 710 of this embodiment is configured for disposition exterior of the container 712 (e.g., similar to the embodiment of FIGS. 1-10) but otherwise comprises an outer dispensing member 714 and an inner dispensing member 716 that are assembled together to define the dispenser.

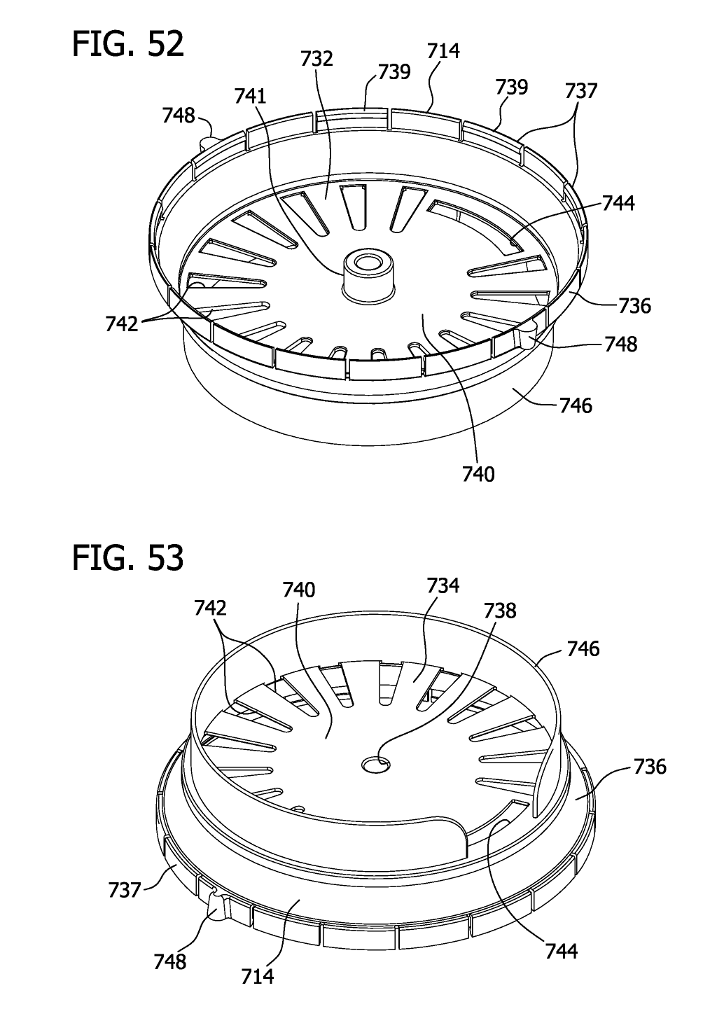

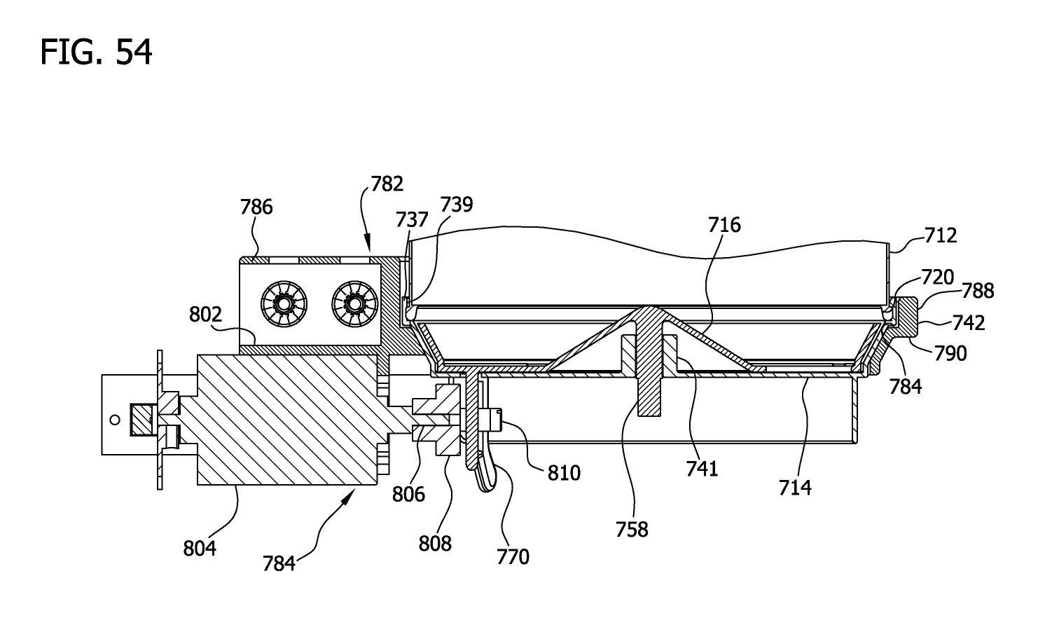

The outer dispensing member 714 of this embodiment, as best seen in FIGS. 52 and 53, has an inner surface 732, an outer surface 734, and a sidewall 736. The sidewall 736 of the outer dispensing member 714 includes a plurality of resilient fingers 737 capable of radial deflection relative to the rest of the sidewall. Each of the resilient fingers 737 includes a radially inward extending catch 739 to resiliently retain the rim of the container 512 as illustrated in FIG. 54. A pair of alignment tabs 748 extend radially outward from the sidewall 736 to facilitate proper alignment of the packaging on the mount 782 of the dispensing appliance as illustrated in FIG. 51 and discussed in further detail later herein.

The outer dispensing member 714 includes a central opening 738 and a hub 741 projecting longitudinally inward from the inner surface 732 at the central opening. The outer dispensing member 714 of the illustrated embodiment includes a central region 740 surrounding the hub 741 that is generally planar (e.g., instead of conical). The outer dispensing member 714 of this embodiment also includes a plurality of exit openings 742 (sixteen are illustrated in this embodiment) similar to the exit openings 542 of the embodiment of FIGS. 34-41. An elongate, circumferentially slot 744 is also disposed in the outer dispensing member 714. A portion of the sidewall 736 is sloped longitudinally inward, and radially outward from a location radially adjacent the exit openings 742. A generally annular (although not fully annular) deflector 746 is disposed radially outward of but generally adjacent to the exit openings 742 of the outer dispensing member 714 for the same reasons discussed in connection with the embodiment of FIGS. 34-41.

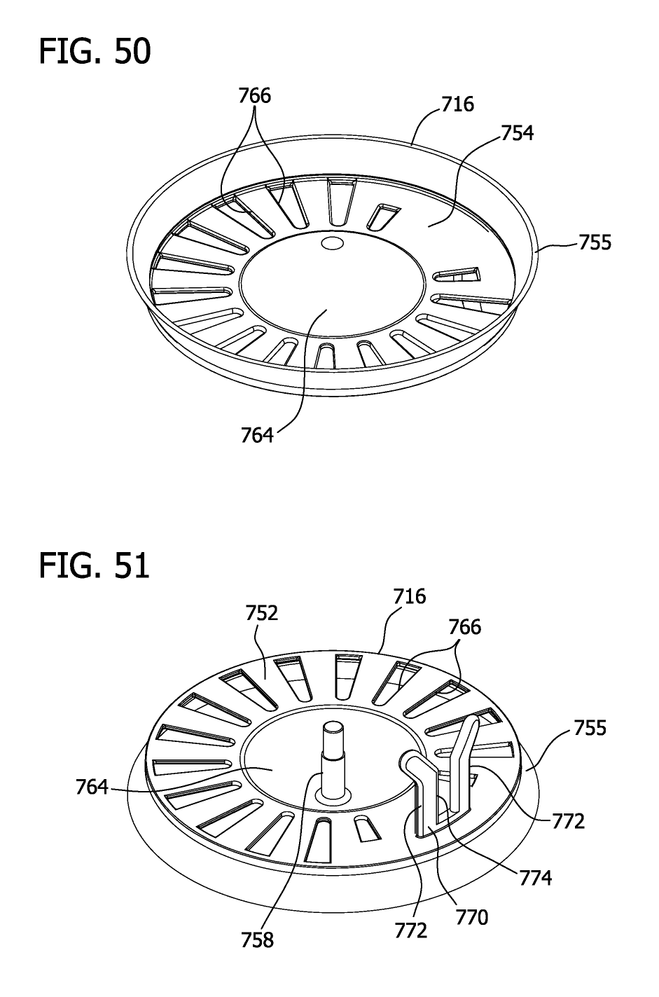

With particular reference to FIGS. 50 and 51, the inner dispensing member 716 of this embodiment is generally disc-shaped, having an inner surface 754 that in part defines the interior space of the packaging, and an outer surface 752 for opposed relationship with the inner surface 732 of the outer dispensing member 714. In this embodiment, the inner dispensing member 716 includes a sloped sidewall 755 to correspond with the sloped portion of the sidewall 736 of the outer dispensing member 714 so that the inner dispensing member generally nests within the outer dispensing member. The inner dispensing member 716 has a generally conical central region 764 and an axle member 758 (generally in the form of a post in this embodiment) depending from the outer surface 752 of the inner dispensing member at the center of the central region. The axle member 758 is sized for insertion through the central opening 738 and hub 741 of the outer dispensing member 714 as illustrated in FIG. 54 to facilitate rotation of the inner dispensing member relative to the outer dispensing member on a dispenser rotation axis D defined by the axle member of the inner dispensing member.

As in the previous embodiment, the inner dispensing member 716 has dispensing openings 766 that correspond to respective ones of the exit openings 742 in the outer dispensing member 714 such that the inner dispensing member is rotatable relative to the outer dispensing member between a blocked position of the dispenser 710 and a dispensing position of the dispenser as described in connection with the previous embodiment. A generally U-shaped drive coupling 770 (FIG. 51) projects longitudinally outward from the outer surface 752 of the inner dispensing member 716 to define a pair of guide posts 772 with an elongate slot 774 extending longitudinally therebetween. More particularly, in the illustrated embodiment the drive coupling 770 is formed integrally with the inner dispensing member 716. However, it is understood that the drive coupling 770 may be formed separate from the inner dispensing member 716 and attached thereto by any suitable attachment technique. It is also contemplated that the drive coupling 770 may alternatively be formed by a pair of guide posts that are attached directly to the inner dispensing member 716 in circumferentially spaced relationship with each other to define an elongate slot therebetween.

The drive coupling 770, and in particular the spacing between the circumferentially outer edges of the guide posts 772, is such that the drive coupling is insertable through and positionable within the elongate circumferential slot 744 in the outer dispensing member 714 as illustrated in FIG. 54 for operative connection with a drive system 784 of a dispensing appliance. In particular, the drive coupling 770 is moveable within the slot 744 to permit oscillating rotary movement of the inner dispensing member 716 relative to the outer dispensing member 714 while the drive coupling remains within the slot in the outer dispensing member 714.

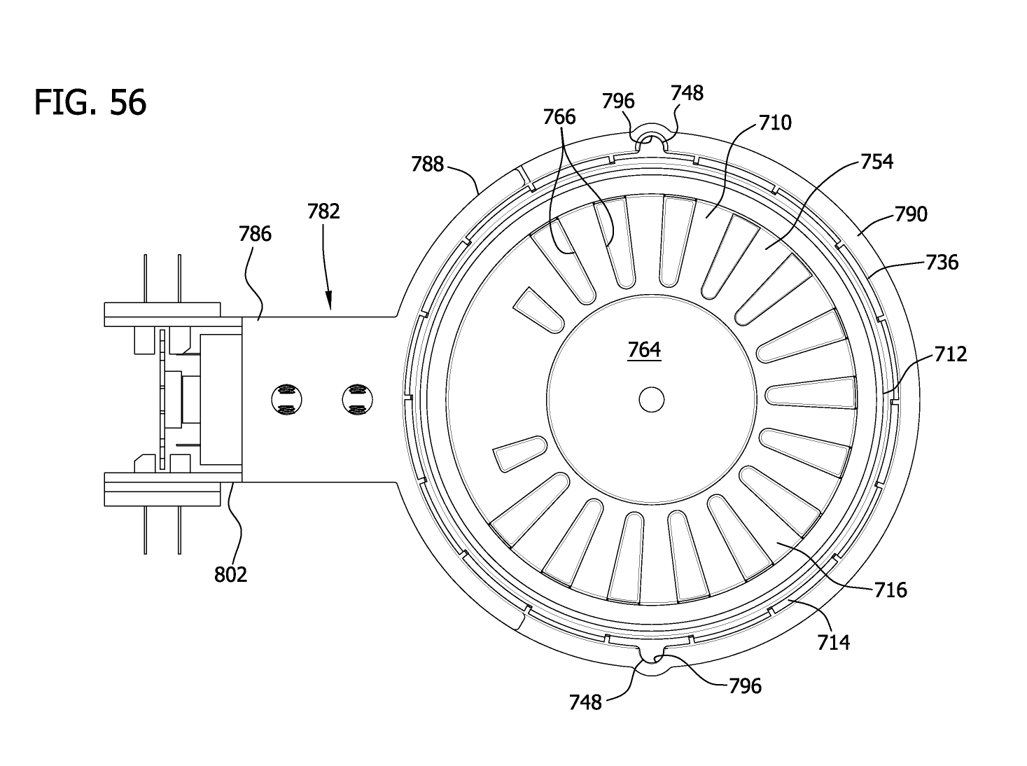

FIGS. 54-56 illustrate a suitable dispensing appliance mount, generally indicated at 782, for mounting the packaging of FIGS. 48-53 in a dispensing appliance. The mount 782 of this embodiment includes a transversely extending mounting arm 786 configured for connection with suitable structure (not shown) of the dispensing appliance. An annular seat 788 extends transversely outward from the mounting arm 786 and includes an annular sidewall 790 that is sloped in accordance with the sloped portion of the outer dispensing member sidewall 736 for properly seating and supporting the packaging on the annular seat of the mount 782. An upright portion 792 of the annular sidewall 790 of the seat 788 extends upward from the sloped portion thereof and forms a shoulder 794 on which the flanged portion of the outer dispensing member 716 seats upon insertion of the packaging into the mount 782. A pair of notches 796 are formed in the radially inner surface of the annular sidewall 790 to accommodate the tabs 748 disposed on the sidewall 736 of the outer dispensing member 714 to facilitate proper angular alignment of the packaging on the mount 782 as illustrated in FIG. 56.

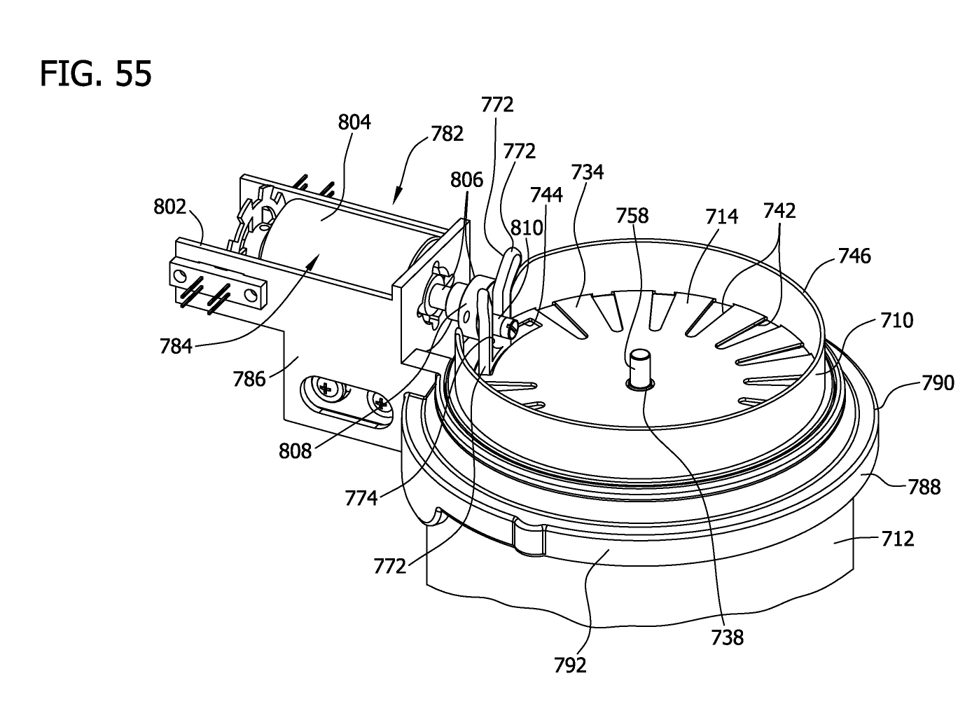

A drive system housing 802 is attached to and depends from the mounting arm 786, and houses a drive system 784 including a motor 804 and corresponding drive shaft 806. An eccentric drive plate 808 is mounted on the drive shaft 806 and includes an eccentric pin 810 extending outward therefrom such that the motor 804 operates to drive orbital rotation of the eccentric pin about a rotation axis M defined by the drive shaft. In this embodiment, the eccentric drive plate 808 and pin 810 are disposed transversely outward of the drive system housing 802, with the eccentric pin received within the slot 774 of the drive coupling 770 as illustrated best in FIG. 55.

To releasably mount the packaging (i.e., the cartridge) on the dispensing appliance mount 782, the packaging is inverted, e.g., as illustrated in FIG. 48, and inserted downward into the annular seat 788 of the mount. The tabs 748 on the sidewall 736 of the outer dispensing member 714 are angularly aligned with the notches 796 in the sidewall 790 of the annular seat 788 and the packaging is lowered into the annular seat with the tabs received into the corresponding notches. The outer dispensing member 714 nests into and thus seats on the sloped portion of the annular seat sidewall 790 as well as on the shoulder 794 of thereof with the deflector 746 of the outer dispensing member extending down below the annular seat 788 of the mount 782. Upon insertion of the packaging into the annular seat 788, the eccentric pin 810 of the drive system 784 is received in the slot 774 of the drive coupling 770 that depends from the inner dispensing member 716 to operatively connect the inner dispensing member to the drive system. While in the illustrated embodiment the packaging is releasably supported by but is otherwise not secured on the mount 782, it is understood that a connection similar to that of the previous embodiment may be used within the scope of this invention.

In operation to dispense powdered beverage from the packaging, the motor 804 is operated (e.g., such as by a suitable on/off button and more suitably by a control system programmed for operating the dispenser 710 to dispense a predetermined quantity of powdered beverage) to drive rotation of the eccentric pin 810. Rotation of the eccentric pin 810 drives the drive coupling 770 to oscillate in rotary motion within the slot 744 of the outer dispensing member 714, thus rotatably oscillating the inner dispensing member 716 relative to the outer dispensing member. Rotary movement of the inner dispensing member 716 in this manner repeatedly positions the dispenser 710 between its blocked position and its dispensing position to intermittently dispense powdered beverage from the packaging container 712 until a predetermined quantity of powdered beverage is dispensed.

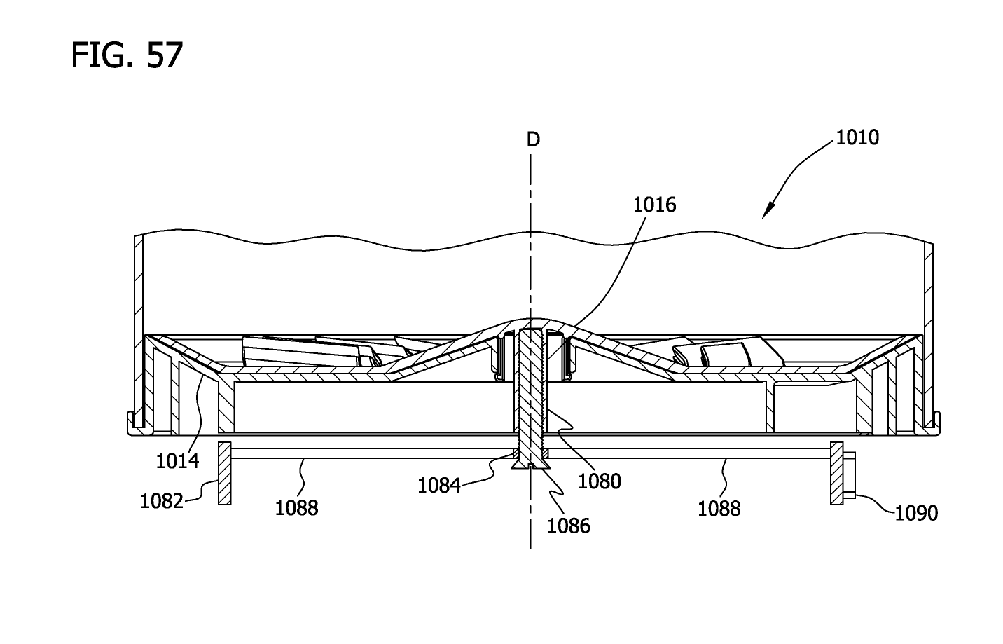

In an alternative embodiment illustrated in FIG. 57, a dispenser 1010 is similar in construction to the dispenser 710 of FIGS. 55 and 56, with the exception that the dispenser of this embodiment is configured to be driven at its central rotation axis D. In particular, the inner dispensing member 1016 includes a hollow, internally threaded shaft 1080 on the rotation axis D thereof. A drive ring 1082 is configured for disposition below the outer dispensing member 1014 and includes a hub 1084 that is also internally threaded such that a suitable threaded fastener 1086 may extend up through the hub into the threaded shaft 1080 to rotatably couple the inner dispensing member 1016 to the drive ring for conjoint rotation. Suitable spoke members 1088 (two are illustrated in FIG. 57) connect the hub 1084 to the drive ring 1082 to permit powder dispensed from the dispenser to pass through the drive ring. A suitable coupling 1090 (e.g., in the form of a pair of tabs that are circumferentially spaced from each other to define an elongate slot therebetween) is attached to the outer surface of the drive ring and is configured for operative coupling with the drive motor substantially in the manner illustrated in FIG. 55. Accordingly, operation of the drive motor rotatably drives (either in oscillation or continuous rotation) the drive ring 1082. The drive ring, via the operative connection with the inner dispensing member 1016, conjointly drives rotation of the inner dispensing member about the rotation axis D to dispense powder from the container. In this manner, the rotational forces transmitted to the inner dispensing member by the drive system are generally centrally (e.g., at the axis D) of the inner dispensing member 1016.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A dispensing appliance for dispensing a beverage from a container of powdered beverage, the dispensing appliance comprising:
a housing having an interior space and an exit through which beverage is dispensed from the housing;
a dispenser connectable to the container with the dispenser interfacing with the powdered beverage in the container, the dispenser being positionable between a blocking position in which powdered beverage is inhibited against dispensing from the container, and a dispensing position in which powdered beverage is dispensed from the container, the dispenser being releasably securable at least one of on and within the housing to permit removal of the dispenser from the housing; and
a drive system configured for operative connection with the dispenser to operate the dispenser to dispense powdered beverage from the container.

2. The dispensing appliance of claim 1 further comprising a powder delivery system configured to direct powdered beverage dispensed from the container by the dispenser to the exit of the housing to thereby dispense beverage from the appliance in the form of a powdered beverage.

3. The dispensing appliance of claim 1 further comprising a liquid delivery system in communication with a source of liquid, the liquid delivery system being operable to direct liquid from the source of liquid to the exit of the housing.

4. The dispensing appliance of claim 1 wherein the dispenser is operable to dispense a predetermined quantity of powdered beverage from the container.

5. The dispensing appliance of claim 4 wherein the appliance further comprises a control system by which a user selects a predetermined amount of beverage to be dispensed by the appliance, the predetermined quantity of powdered beverage dispensed by the dispenser being at least in part a function of the predetermined amount of beverage to be dispensed.

6. The dispensing appliance of claim 1 wherein the dispenser comprises:
an outer dispensing member having an exit opening through which powdered beverage can be dispensed, and
an inner dispensing member in opposed relationship with the outer dispensing member and disposed longitudinally inward of the outer dispensing member and in part defining an interior space of the container upon connection of the dispenser to the container, the inner dispensing member having at least one dispensing opening, at least one of the outer dispensing member and the inner dispensing member being moveable relative to the other one of the outer dispensing member and the inner dispensing member between a blocked position of the dispenser in which the at least one opening of the inner dispensing member is out of registry with the exit opening of the outer member to inhibit dispensing of powdered beverage from the container, and a dispensing position of the dispenser in which the at least one opening of the inner dispensing member is at least in part aligned with the exit opening of the outer member to permit powdered beverage to be dispensed from the container;
the drive system being operatively connected to the at least one of the inner dispensing member and the outer dispensing member for driving movement thereof to dispense powdered beverage from the container.

7. The dispensing appliance of claim 6 wherein the drive system and dispenser are configured for oscillating movement of the at least one of the inner dispensing member and the outer dispensing member between the blocked position of the dispenser and the dispensing position of the dispenser to intermittently dispense powdered beverage from the container.

8. The dispensing appliance of claim 6 wherein the drive system comprises an electric motor and an output shaft, the appliance further comprising a drive coupling configured for operatively connecting the drive shaft with the dispenser.

9. The dispensing appliance of claim 8 wherein the drive shaft has a rotation axis, the appliance further comprising an eccentric drive plate mounted on the drive shaft, and an eccentric pin projecting from the drive plate radially offset from the rotation axis of the drive shaft, the drive coupling operatively connecting the eccentric pin with the dispenser to permit oscillating movement of the at least one of the inner dispensing member and the outer dispensing member.

10. The dispensing appliance of claim 6 wherein the at least one of the inner dispensing member and the outer dispensing member is rotatable relative to the other one of the inner dispensing member and the outer dispensing member.

11. The dispensing appliance of claim 10 wherein the drive system comprises a motor and drive shaft having a rotation axis, the at least one of the inner dispensing member and the outer dispensing member being rotatable on a dispenser rotation axis, the drive shaft rotation axis being non-parallel to the dispenser rotation axis.

12. The dispensing appliance of claim 11 wherein the drive shaft rotation axis is perpendicular to the dispenser rotation axis.

13. The dispensing appliance of claim 3 further comprising a mixing station in communication with the liquid delivery system and adapted to receive powdered beverage into the mixing system, the mixing station being capable of mixing together the powdered beverage and liquid prior to the mixture being dispensed from the appliance as a generally liquid beverage.

14. A dispensing appliance for dispensing a beverage, the appliance comprising:
a cartridge comprising a container containing powdered beverage, and a dispenser on the container operable to dispense powdered beverage from the container,
a mount for removably supporting the cartridge on the dispensing appliance; and
a drive system configured for operative connection with the dispenser upon loading of the cartridge into the mount, the drive system being operable to operate the dispenser to release powdered beverage from the container.

15. The dispensing appliance of claim 14 further comprising a powder delivery system configured to direct powdered beverage dispensed from the container by the dispenser to the exit of the housing to thereby dispense beverage from the appliance in the form of a powdered beverage.

16. The dispensing appliance of claim 14 further comprising a liquid delivery system in communication with a source of liquid, the liquid delivery system being operable to direct liquid from the source of liquid to the exit of the housing.

17. The dispensing appliance of claim 16 further comprising a mixing station in communication with the liquid delivery system and adapted to receive powdered beverage into the mixing system, the mixing station being capable of mixing together the powdered beverage and liquid prior to the mixture being dispensed from the appliance as a generally liquid beverage.

18. The dispensing appliance of claim 14 wherein the dispenser is operable to dispense a predetermined quantity of powdered beverage from the cartridge.

19. The dispensing appliance of claim 18 wherein the appliance further comprises a control system by which a user selects a predetermined amount of beverage to be dispensed by the appliance, the predetermined quantity of powdered beverage dispensed by the dispenser being at least in part a function of the predetermined amount of beverage to be dispensed from the appliance.

20. The dispensing appliance of claim 14 further comprising a housing having an interior space and an exit through which beverage is dispensed from the housing, the mount being disposed at least one of on and within the housing.

21. The dispensing appliance of claim 14 wherein at least one of the mount and the cartridge comprises an alignment member to facilitate proper alignment of the cartridge on the mount with the drive system in operative connection with the cartridge dispenser.

22. The dispensing appliance of claim 22 wherein the mount includes one of a male alignment member and a female alignment member, the cartridge including the opposite one of a male alignment member and a female alignment member, the cartridge being rotatable on the mount until the alignment member of the cartridge interengages the alignment member of the mount to indicate the proper orientation of the cartridge on the mount.

23. The dispensing appliance of claim 14 wherein the cartridge and the mount are configured for releasably securing the cartridge on the mount with the drive system operatively connected with the dispenser of the cartridge.

24. The dispensing appliance of claim 22 wherein the cartridge has a snip-fit connection with the mount to releasably secure the cartridge on the mount.

25. The dispensing appliance of claim 14 wherein the powdered beverage is a powdered nutritional beverage.

26. The dispensing appliance of claim 25 wherein the powdered beverage is one of an infant formula, a follow-on formula, an adult supplement and an adult nutritional powder.

27. The dispensing appliance of claim 14 wherein the dispenser comprises:
an outer dispensing member having an exit opening through which powdered beverage can be dispensed, and
an inner dispensing member in opposed relationship with the outer dispensing member and disposed longitudinally inward of the outer dispensing member and in part defining an interior space of the container, the inner dispensing member having at least one dispensing opening, at least one of the outer dispensing member and the inner dispensing member being moveable relative to the other one of the outer dispensing member and the inner dispensing member between a blocked position of the dispenser in which the at least one opening of the inner dispensing member is out of registry with the exit opening of the outer member to inhibit dispensing of powdered beverage from the container, and a dispensing position of the dispenser in which the at least one opening of the inner dispensing member is at least in part aligned with the exit opening of the outer member to permit powdered beverage to be dispensed from the container;
the drive system being operatively connected to the at least one of the inner dispensing member and the outer dispensing member upon insertion of the cartridge into the mount for driving movement thereof to dispense powdered beverage from the container.

28. The dispensing appliance of claim 27 wherein the drive system and dispenser are configured for oscillating movement of the at least one of the inner dispensing member and the outer dispensing member between the blocked position of the dispenser and the dispensing position of the dispenser to intermittently dispense powdered beverage from the container.

29. The dispensing appliance of claim 27 wherein the drive system comprises an electric motor and a drive shaft, the appliance further comprising a drive coupling configured for operatively connecting the drive shaft with the dispenser.

30. The dispensing appliance of claim 29 wherein the drive coupling is secured to the at least one of the inner dispensing member and the outer dispensing member and is configured for operative connection with the drive shaft upon insertion of the cartridge into the mount.

31. The dispensing appliance of claim 29 wherein the drive shaft has a rotation axis, the appliance further comprising an eccentric drive plate mounted on the drive shaft, and an eccentric pin projecting from the drive plate radially offset from the rotation axis of the drive shaft, the drive coupling operatively connecting the eccentric pin with the dispenser to permit oscillating movement of the at least one of the inner dispensing member and the outer dispensing member.

32. The dispensing appliance of claim 27 wherein the at least one of the inner dispensing member and the outer dispensing member is rotatable relative to the other one of the inner dispensing member and the outer dispensing member.

33. The dispensing appliance of claim 32 wherein the drive system comprises a motor and a drive shaft having a rotation axis, the at least one of the inner dispensing member and the outer dispensing member being rotatable on a dispenser rotation axis, the drive shaft rotation axis being non-parallel to the dispenser rotation axis.

34. The dispensing appliance of claim 33 wherein the drive shaft rotation axis is perpendicular to the dispenser rotation axis.

35. The dispensing appliance of claim 14 wherein the cartridge container of the cartridge includes a closed end, a dispensing end generally at which the dispenser is disposed, and a sidewall extending therebetween, the cartridge and the mount being configured such that the cartridge is oriented with the dispensing end of the container below the closed end thereof upon being positioned on the mount.

36. A method of refilling a dispensing appliance for powdered beverage, the method comprising:
dismounting a first cartridge from a mount of the dispensing appliance, the cartridge including a container and a powder dispenser secured thereto;
disconnecting the dispenser of said first cartridge from a drive system of the dispensing appliance;
mounting a second cartridge, different from said first cartridge, on said mount of the dispensing appliance after dismounting said first cartridge and disconnecting said dispenser from the drive system, wherein the second cartridge includes a container and a powder dispenser secured thereto; and
operatively connecting the dispenser of said second cartridge to the drive system of the dispensing appliance.

37. The method set forth in claim 36 wherein said disconnecting is achieved automatically with said dismounting of said first cartridge from said mount.

38. The method set forth in claim 36 wherein said connecting is achieved automatically upon mounting said second cartridge on said mount.

39. The method set forth in claim 36 further comprising removing said first cartridge from a housing of the dispensing appliance one of after said dismounting and simultaneously therewith.

40. The method set forth in claim 39 further comprising inserting said second cartridge in said housing of the dispensing appliance one of before said mounting and simultaneously therewith.

41. The method set forth in claim 36 wherein the cartridge comprises at least one alignment member, the mount comprising at least one corresponding alignment member, the step of mounting a second cartridge on the mount of the dispensing appliance comprising seating the second cartridge on the mount, and angularly repositioning the cartridge relative to the mount until the at least one cartridge alignment member interengages the at least one mount alignment member.

42. The method set forth in claim 36 wherein the step of mounting a second cartridge on the mount of the dispensing appliance comprises releasably securing the second cartridge to the mount.

43. The method set forth in claim 36 wherein the first cartridge is substantially empty of powder and the second cartridge is substantially full of powder.
